(19) United States
(12) Patent Application Publication
(10) Pub. No.: US 2026/0154419 A1
(43) Pub. Date: Jun. 4, 2026

(54) DIAGNOSTIC DEVICE, DIAGNOSTIC METHOD, AND STORAGE MEDIUM

(71) Applicant: NEC Corporation, Tokyo (JP)

(72) Inventors: Hirofumi UEDA, Tokyo (JP); Tomohiko Yagyu, Tokyo (JP); Ryo Mizushima, Tokyo (JP); Shunichi Kinoshita, Tokyo (JP)

(73) Assignee: NEC Corporation, Tokyo (JP)

(21) Appl. No.: 19/386,334

(22) Filed: Nov. 12, 2025

(30) Foreign Application Priority Data
Nov. 29, 2024 (JP) 2024-208044

(51) Int. Cl. G06F 21/57

(52) U.S. Cl. CPC G06F 21/577; G06F 2221/034

(57) ABSTRACT

A diagnostic device according to an aspect of the present disclosure includes: at least one memory storing a set of instructions; and at least one processor configured to execute the set of instructions to: estimate a management impact that is a magnitude of influence on revenue loss resulting due to an attack on a device included in a diagnostic target system based on information on a purpose of the device; identify an entry point device and an attack target device in the device by using information on a configuration of the diagnostic target system and the management impact of the device; detect an attack route through which the attack from the entry point device to the attack target device is capable of being successful; and output information on a diagnostic result indicating the management impact due to the attack on the attack target device through the detected attack route.

This application is based upon and claims the benefit of priority from Japanese Patent Application No. 2024-208044, filed on Nov. 29, 2024, the disclosure of which is incorporated herein in its entirety by reference.

### TECHNICAL FIELD

The present disclosure relates to a diagnostic device, a diagnostic method, and a storage medium.

### BACKGROUND ART

To diagnose security risk of a system to be diagnosed, an expert generally needs to read design information and the like. This diagnosis requires a lot of time and effort.

JP 2022-177379 A describes an assistance system that extracts a security requirement to be compliant and a function of a cloud infrastructure, and instructs design of the cloud infrastructure in which the extracted security requirement and the function of the cloud infrastructure are adjusted. The assistance system of JP 2022-177379 A introduces a security monitoring function based on monitoring target data collected from a monitoring target device into the cloud infrastructure.

### SUMMARY

The cloud infrastructure using the assistance system of JP 2022-177379 A has a security monitoring function based on the monitoring target data collected from the monitoring target device. Thus, time and labor for diagnosing security risk are reduced. Unfortunately, the technique of JP 2022-177379 A does not enable obtaining a magnitude of influence of the security risk on management.

An exemplary object of the present disclosure is to provide a diagnostic device, a diagnostic method, and a storage medium capable of reducing time and labor for obtaining a magnitude of influence of security risk on management.

A diagnostic device according to an aspect of the present disclosure includes: at least one memory storing a set of instructions; and at least one processor configured to execute the set of instructions to: estimate a management impact that is a magnitude of influence on revenue loss resulting due to an attack on a device included in a diagnostic target system based on information on a purpose of the device; identify an entry point device and an attack target device in the device by using information on a configuration of the diagnostic target system and the management impact of the device, the entry point device being a device capable of being caused to be an entry point, the attack target device being a device capable of being caused to be a target of the attack; detect an attack route through which the attack from the entry point device to the attack target device is capable of being successful by using the information on the configuration of the diagnostic target system, information on a state of the device, and information on an attack capable of being successful in the state; and output information on a diagnostic result indicating the management impact due to the attack on the attack target device through the detected attack route.

A diagnostic method according to an aspect of the present disclosure includes: estimating a management impact that is a magnitude of an influence on management due to an attack on a device included in a diagnostic target system based on information on a purpose of the device; identifying an entry point device and an attack target device in the device by using information on a configuration of the diagnostic target system and the management impact of the device, the entry point device being a device capable of being caused to be an entry point, the attack target device being a device capable of being caused to be a target of the attack; detecting an attack route through which the attack from the entry point device to the attack target device is capable of being successful by using the information on the configuration of the diagnostic target system, information on a state of the device, and information on an attack capable of being successful in the state; and outputting information on a diagnostic result indicating the management impact due to the attack on the attack target device through the detected attack route.

A non-transitory computer readable storage medium according to an aspect of the present disclosure stores a program that causes a computer to perform processing, the processing comprising: estimation processing of estimating a management impact that is a magnitude of an influence on management due to an attack on a device included in a diagnostic target system based on information on a purpose of the device; identification processing of identifying an entry point device and an attack target device in the device by using information on a configuration of the diagnostic target system and the management impact of the device, the entry point device being a device capable of being caused to be an entry point, the attack target device being a device capable of being caused to be a target of the attack; detection processing of detecting an attack route through which the attack from the entry point device to the attack target device is capable of being successful by using the information on the configuration of the diagnostic target system, information on states of the devices, and information on an attack capable of being successful in the state; and output processing of outputting information on a diagnostic result indicating the management impact due to the attack on the attack target device through the detected attack route.

The present disclosure has an effect of reducing time and effort for obtaining a magnitude of influence of security risk on management.

### BRIEF DESCRIPTION OF THE DRAWINGS

FIG. 1 is a block diagram illustrating an example of a configuration of a diagnostic device according to the present disclosure;

FIG. 2 is a flowchart illustrating an example of operation of the diagnostic device according to the present disclosure;

FIG. 3 is a block diagram illustrating an example of a configuration of a diagnostic system according to the present disclosure;

FIG. 4 is a block diagram illustrating an example of the configuration of the diagnostic device according to the present disclosure;

FIG. 5 is a flowchart illustrating an example of the operation of the diagnostic device according to the present disclosure;

FIG. 6 is a flowchart illustrating an example of the operation of the diagnostic device according to the present disclosure;

FIG. 7 is a flowchart illustrating an example of the operation of the diagnostic device according to the present disclosure;

FIG. 8 is a flowchart illustrating an example of the operation of the diagnostic device according to the present disclosure;

FIG. 9 is a block diagram illustrating an example of the configuration of the diagnostic device according to the present disclosure;

FIG. 10 is a flowchart illustrating an example of the operation of the diagnostic device according to the present disclosure;

FIG. 11 is a flowchart illustrating an example of operation of the diagnostic device according to the present disclosure in a case where selection information is received; and

FIG. 12 is a diagram illustrating an example of a hardware configuration of a computer capable of implementing the diagnostic device according to the present disclosure.

### EXAMPLE EMBODIMENT

Hereinafter, example embodiments of the present disclosure will be described in detail with reference to the drawings.

### First Example Embodiment

First, a first example embodiment of the present disclosure will be described in detail with reference to the drawings.

### Configuration

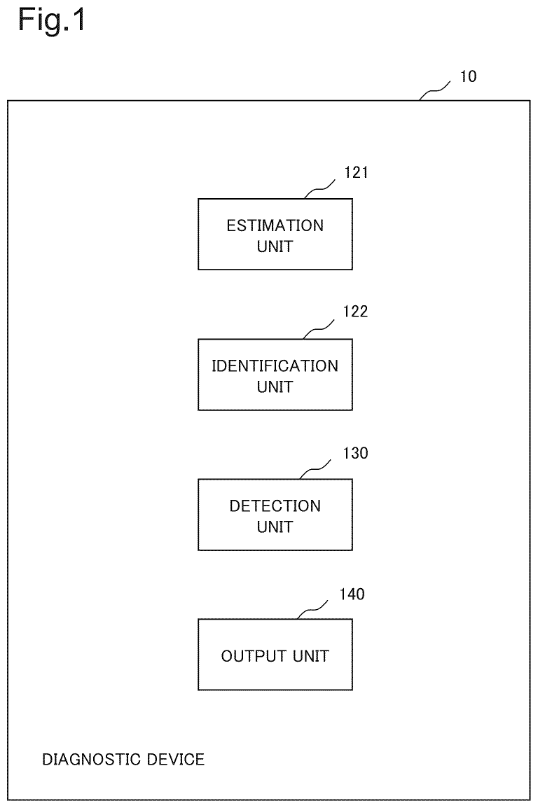

FIG. 1 is a block diagram illustrating an example of a configuration of a diagnostic device according to the present disclosure.

Hereinafter, an example of a configuration of a diagnostic device according to a first example embodiment of the present disclosure will be described in detail with reference to FIG. 1.

FIG. 1 illustrates the example in which a diagnostic device 10 includes an estimation unit 121, an identification unit 122, a detection unit 130, and an output unit 140.

### Estimation Unit 121

The estimation unit 121 estimates a management impact, which is a magnitude of influence on revenue loss resulting due to an attack on a device, by using information on a purpose of a device included in a diagnostic target system. The management impact includes information that may include information indicating a magnitude of influence on the revenue loss resulting due to an attack on a target device and information indicating the device. Hereinafter, the term, “management impact of a device”, indicates the management impact of the device described above.

Identification unit 122

The identification unit 122 identifies an entry point device and an attack target device in devices included in the diagnostic target system by using information on a configuration of the diagnostic target system and the management impact of the device. The entry point device is a device capable of being caused to be an entry point. The attack target device is a device capable of being caused to be a target of the attack.

### Detection Unit 130

The detection unit 130 detects an attack route through which the attack from the entry point device to the attack target device is capable of being successful by using the information on the configuration of the diagnostic target system, information on states of the devices, and information on an attack capable of being successful in the states.

### Output Unit 140

The output unit 140 outputs information on a diagnostic result indicating the management impact due to the attack on the attack target device through the detected attack route.

### Details

### Estimation Unit 121

The information on a purpose of the device is information representing the purpose of the device, for example. The purpose of the devices may be management of production of a product, for example. In this case, the information on the purpose of the device includes information on a product manufactured using the device and sales of the product, information on another product in which the product is used as a component and sales of the another product, and the like. The information on the product may include information such as a name of the product and a shipping destination of the product.

The information on the purpose of the device may be storage of information, for example. For the storage of information, the information on the purpose of the devices may include information representing contents of the information stored in a storage in the device, which is also referred to as stored information in the following description. The information on the purpose of the devices may also include information on an estimated loss (e.g., a total of the amount of decrease in sales and the amount of expected compensation) in a case where the stored information is leaked.

The information on the purpose of the devices is not limited to these examples. The device may have a plurality of purposes. For example, a device used for management of manufacturing of a product may be used for storage of information.

A magnitude of influence on revenue loss may be represented by an amount of money, for example. In a case where the purpose of the devices is management of manufacturing of a product, the magnitude of influence on the revenue loss resulting due to an attack on the device may be represented by sales (referred to below also as affected sales) of the product for which manufacturing is affected by a stop of the device and a manufactured product in which the product is used, for example. The sales may be represented by sales within a period of a predetermined typical length in a period in which the device being attacked is stopped. In a case where the purpose of the device is storage of information, the magnitude of influence on revenue loss resulting due to an attack on the device may be represented by an estimated loss in a case where the stored information is leaked, for example.

The magnitude of influence on revenue loss may be represented by any one of a plurality of predetermined levels, for example. For the levels, a range of the affected sales and a range of the loss may be each divided into a plurality of ranges, for example. A level may be associated with each of the plurality of ranges. The magnitude of influence on revenue loss may be also represented by a level associated with a range including the affected sales and the loss.

### Identification Unit 122

The diagnostic target system is an information processing system implemented by devices and a communication network connecting the devices. The devices include an information processing device. The devices may further include communication devices such as a router and a switch. The devices are communicably connected to another device. At least some of the devices may be connected to the outside of the diagnostic target system.

The information on the configuration of the diagnostic target system may include information representing a network configuration of devices included in the diagnostic target system. The network configuration of the devices is information representing the devices connected to each other through a communication network, for example.

The information on states of the devices includes at least one of information on vulnerability existing in the devices and information on security setting of the devices, for example. The states of the devices represent at least any one of vulnerability of the devices and a security state of the devices.

For example, the identification unit 122 identifies a device that can be directly accessed from the outside of the diagnostic target system as the entry point device among the devices included in the diagnostic target system. The identification unit 122 identifies an attack target device from the devices included in the diagnostic target system by using a magnitude of the management impact. For example, the identification unit 122 may identify a device having a management impact equal to or more than a predetermined standard as the attack target device among the devices included in the diagnostic target system. For example, the identification unit 122 may identify a device having the largest management impact as the attack target device among the devices included in the diagnostic target system. The identification unit 122 may identify a plurality of entry point devices. The identification unit 122 may identify a plurality of attack target devices.

### Detection Unit 130

The information on an attack capable of being successful for each of the states represents a state of a device and an attack capable of being successful in the device while the device is in the state. The information on an attack capable of being successful for each of the states may be obtained for each type of device. Information may be obtained, the information representing a plurality of states of a device and an attack capable of being successful in the device for each state in a case where the device is in the state.

The detection unit 130 detects an attack route through which the attack from the entry point device to the attack target device is capable of being successful using any one of various existing methods. The detection unit 130 may detect the attack route using the technique described in WO 2023/089669 A1, for example. The detection unit 130 may detect the attack route using another method. In a case where a plurality of entry point devices is identified, the detection unit 130 may detect an attack route to the attack target device from each of the plurality of entry point devices. In a case where a plurality of attack target devices is identified, the detection unit 130 may detect an attack route from the entry point device to each of the plurality of attack target devices. In a case where a plurality of entry point devices and a plurality of attack target devices are identified, the detection unit 130 may detect an attack route from each of the plurality of entry point devices to each of the plurality of attack target devices.

### Output Unit 140

As described above, the output unit 140 outputs information on a diagnostic result indicating the management impact due to the attack on the attack target device through the detected attack route.

For example, the output unit 140 may output information representing the management impact representing a magnitude of influence on the revenue loss resulting due to the attack on the attack target device as the information on the diagnostic result for each attack target device capable of being attacked through the detected attack route.

The output unit 140 may further output information representing the detected attack for each attack target device capable of being attacked through the detected attack route.

### Operation

Next, operation of the first example embodiment of the present disclosure will be described in detail with reference to the drawings.

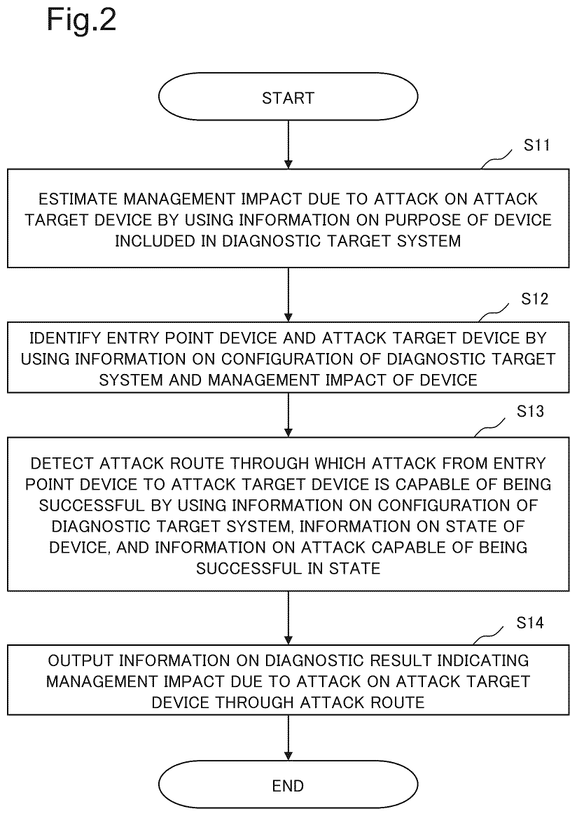

FIG. 2 is a flowchart illustrating an example of operation of the diagnostic device according to the present disclosure.

Hereinafter, an example of operation of the diagnostic device according to the first example embodiment of the present disclosure will be described in detail with reference to FIG. 2.

FIG. 2 illustrates the example in which the estimation unit 121 estimates management impact due to an attack on an attack target device with reference to the information on the purpose of the devices included in the diagnostic target system (step S11). Next, the identification unit 122 identifies an entry point device and the attack target device with reference to the information on the configuration of the diagnostic target system and the management impact of each of the devices (step S12). Subsequently, the detection unit 130 detects an attack route through which the attack from the entry point device to the attack target device is capable of being successful using the information on the configuration of the diagnostic target system, information on states of the devices, and information on an attack capable of being successful for each of the states (step S13). Then, the output unit 140 outputs information on a diagnostic result indicating the management impact due to the attack on the attack target device through the attack route (step S14).

### Effects

The present example embodiment described above has an effect of reducing time and effort for obtaining a magnitude of influence of security risk on management.

This is because the estimation unit 121 estimates a management impact, which is a magnitude of influence on revenue loss resulting due to an attack on a device, with reference to information on the purpose of the devices included in the diagnostic target system. This is also because the identification unit 122 identifies an entry point device capable of being caused to be an entry point and an attack target device capable of being caused to be a target of the attack among the devices with reference to information on a configuration of the diagnostic target system and the management impact of each of the devices. This is still because the detection unit 130 detects an attack route through which the attack from the entry point device to the attack target device is capable of being successful using the information on the configuration of the diagnostic target system, information on states of the devices, and information on an attack capable of being successful for each of the states. This is still because the output unit 140 outputs information on a diagnostic result indicating the management impact due to the attack on the attack target device through the detected attack route. As described above, the diagnostic device 10 derives a magnitude (i.e., the management impact described above) of influence of security risk (e.g., an attack on an attack target device through an attack route through which the attack can be successful) on management. That is, the diagnostic device 10 derives the magnitude of the influence of the security risk on the management without relying on manpower. Thus, the diagnostic target system enables time and labor to be reduced as compared with in a case where the magnitude of the influence of the security risk on the management is manually analyzed.

### Second Example Embodiment

First, a second example embodiment of the present disclosure will be described in detail with reference to the drawings. Unless otherwise specified, the same terms used in the second example embodiment as the terms used in the first example embodiment refer to the same terms used in the first example embodiment.

### Configuration

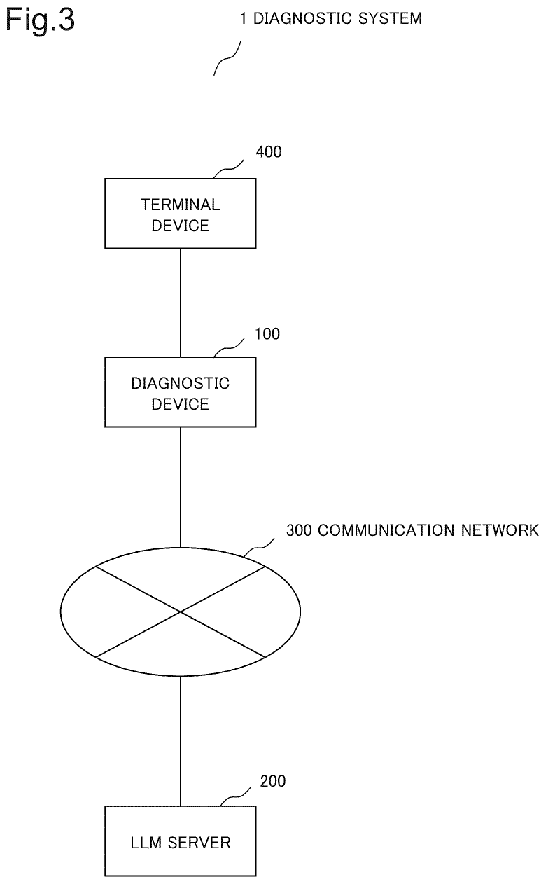

FIG. 3 is a block diagram illustrating an example of a configuration of a diagnostic system according to the present disclosure.

Hereinafter, an example of a configuration of a diagnostic system according to the second example embodiment of the present disclosure will be described in detail with reference to FIG. 3.

FIG. 3 illustrates the example in which a diagnostic system 1 includes a diagnostic device 100, an LLM server 200 in which a large language model (LLM) operates, and a terminal device 400. The diagnostic device 100 and the LLM server 200 are communicably connected through a communication network 300. The diagnostic device 100 and the terminal device 400 are communicably connected. The terminal device 400 may be connected to the communication network 300. In this connection, the diagnostic device 100 and the terminal device 400 are communicably connected through the communication network 300. The communication network 300 does not refer to the communication network of the diagnostic target system described in the first example embodiment.

The large language model receives a textual instruction from the diagnostic device 100 and returns a result for the received instruction to the diagnostic device 100, for example. The large language model may be one of various existing large language models.

The terminal device 400 is an information processing device used by a user to instruct the diagnostic device 100 to diagnose the diagnostic target system.

### Diagnostic Device 100

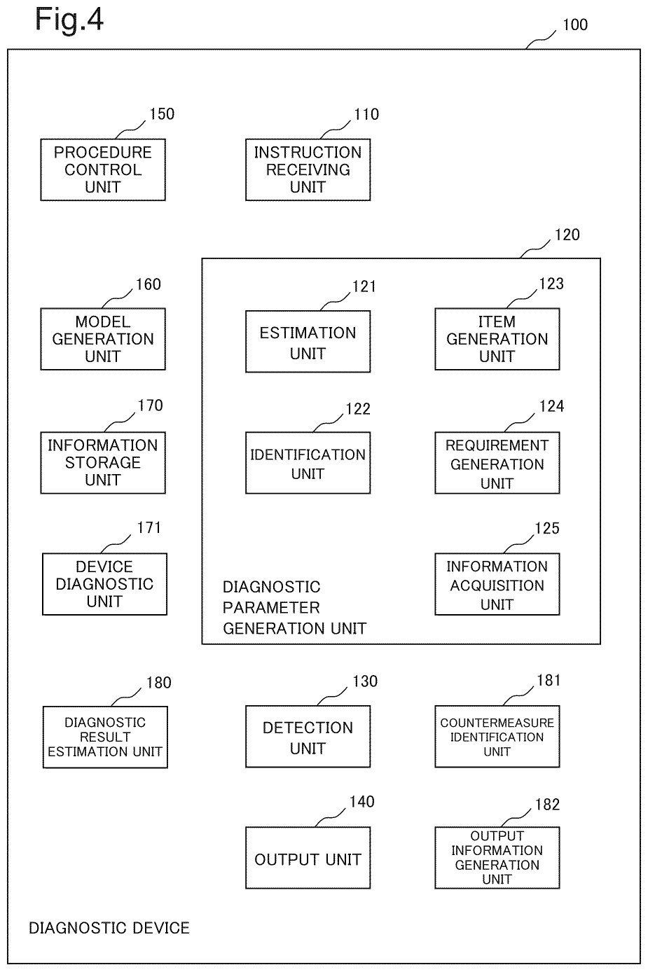

FIG. 4 is a block diagram illustrating an example of a configuration of the diagnostic device according to the present disclosure.

Hereinafter, the diagnostic device according to the second example embodiment of the present disclosure will be described in detail with reference to FIG. 4.

FIG. 4 illustrates the example in which the diagnostic device 100 includes an instruction receiving unit 110, a diagnostic parameter generation unit 120, a detection unit 130, an output unit 140, a procedure control unit 150, a model generation unit 160, an information storage unit 170, a device diagnostic unit 171, a diagnostic result estimation unit 180, a countermeasure identification unit 181, and an output information generation unit 182. The diagnostic parameter generation unit 120 includes an estimation unit 121, an identification unit 122, an item generation unit 123, a requirement generation unit 124, and an information acquisition unit 125.

### Instruction Receiving Unit 110

The instruction receiving unit 110 receives an instruction for diagnosis of the diagnostic target system from the terminal device 400. The instruction for diagnosis of the diagnostic target system may include information indicating the diagnostic target system and a diagnostic request that is information indicating contents of desired diagnostic. The instruction for diagnosis of the diagnostic target system may be described in text. The instruction receiving unit 110 identifies the diagnostic target system from the received instruction. The instruction receiving unit 110 further identifies the diagnostic request from the received instruction.

Information identifying the diagnostic target system may be a name of the diagnostic target system. For the identification, the name of the diagnostic target system may be one predetermined name of the diagnostic target system. The information on the configuration of the diagnostic target system and information on the devices included in the diagnostic target system may be given to the diagnostic device 100 in advance and stored in the information storage unit 170 described in detail later. For example, the instruction receiving unit 110 may receive the information on the configuration of the diagnostic target system and the information on the devices included in the diagnostic target system from the terminal device 400 or another server that holds the information on the configuration of the diagnostic target system and the information on the devices included in the diagnostic target system.

Examples of the diagnostic request include a request for diagnosis of any one of types of influence on management. Examples of the types of influence on management include the loss and rule violation. The examples of the diagnostic request also include a request for diagnosis of the loss, a request for diagnosis of rule violation, and a request for diagnosis of the loss and the rule violation. The present disclosure also indicates the diagnostic request as a content instruction. Contents of the content instruction refer to the types of influence on management indicated by the diagnostic request.

Examples of the loss include the loss due to production stoppage, that is, the amount of decrease in sales due to stoppage of shipment of a product whose manufacture is stopped due to an attack on a device affecting the manufacture of the product and another product in which the product is incorporated. Examples of the loss due to the production stoppage may include a total amount of the amount of decrease in sales described above and an expected value of the amount of compensation of damage to be paid to a shipping destination due to the stoppage of shipping of the product and the another product in which the product is incorporated, the stoppage of shipping being caused by the production stoppage of the product. Examples of the loss may include an estimated value (referred to below as the loss due to an attack) of the amount of decrease in sales due to decrease in credibility and damage to an image of the product caused by the production stoppage of the product due to an attack and the stoppage of shipping of the product and the another product in which the product is incorporated. The loss may be a total of the loss due to the production stoppage and the loss due to the attack.

Examples of the rule include a law. In this example, the rule violation is law violation. The rule may include a guideline. In this example, the rule violation means violation of at least one of the law and the guideline. The guideline is defined depending on the purpose of the diagnostic target system, for example.

### Procedure Control Unit 150

The procedure control unit 150 controls processing of the diagnostic device 100. That is, the procedure control unit 150 instructs a component of the diagnostic device 100 to perform processing, the component performing the processing next, according to a processing stage of the diagnostic device 100. For example, in a case where the instruction receiving unit 110 receives an instruction of diagnostic of the diagnostic target system, the procedure control unit 150 transmits an instruction to acquire information on a device of the diagnostic target system to the device diagnostic unit 171. In a case where obtaining a state of the device of the diagnostic target system, the procedure control unit 150 instructs the model generation unit 160 to generate a virtual model of the diagnostic target system and instructs the diagnostic parameter generation unit 120 to generate a diagnostic parameter. The virtual model and the diagnostic parameter will be described in detail later.

In a case where the virtual model and the diagnostic parameter are generated, the procedure control unit 150 may instruct the detection unit 130 to detect an attack route. In a case where the detection of the attack route is completed, the procedure control unit 150 may transmit an instruction to estimate a diagnostic result to the diagnostic result estimation unit 180. In a case where the estimation of the diagnostic result is completed, the procedure control unit 150 may transmit an instruction to identify a countermeasure to the countermeasure identification unit 181. In a case where the specification of the countermeasure is completed, the procedure control unit 150 may transmit an instruction to generate output information to the output information generation unit 182. In a case where the generation of the output information is completed, the procedure control unit 150 may transmit the output information to the output unit 140.

In a case where information necessary for processing has not been obtained, the procedure control unit 150 may output a request for input of the information necessary for processing and not having been obtained to the terminal device 400. Then, the procedure control unit 150 may receive the information necessary for processing and not having been obtained, the information being input in response to the request. For example, in a case where the information on the configuration of the diagnostic target system is not stored in the information storage unit 170, the procedure control unit 150 may output information requesting input of the information on the configuration of the diagnostic target system.

### Device Diagnostic Unit 171

The device diagnostic unit 171 acquires information on states of devices included in the diagnostic target system.

In a case where the information storage unit 170 is configured to store the information on the states of the devices included in the diagnostic target system, the device diagnostic unit 171 may read the information on the states of the devices included in the diagnostic target system with reference to the information storage unit 170.

The information storage unit 170 may store information on vulnerability for each type of device. The information on vulnerability may include information on risk in a case where an attack on a device in which the vulnerability exists is successful (in other words, a type of damage, such as a matter that can be performed by an attacker in the device in a case where the attack is successful, and the like). The information on vulnerability may include information on conditions (e.g., under which a device performs a specific operation, a user of the device performs a specific type of operation such as web access, and a specific type of operation is performed on the device) under which risk (i.e., a type of damage indicated by the risk) occurs.

The information on vulnerability for each device may be represented by information on vulnerability having been discovered for each version of software of the device and information on vulnerability for which each countermeasure of a security countermeasure program (referred to also as a security patch) has been taken, for example. Examples of the software of the device include an operating system (OS) and a program such as a driver to be executed in the device. The information on vulnerability may include information on vulnerability for which a countermeasure has been taken for each version of firmware of the device.

Then, the device diagnostic unit 171 acquires information on a type of device and a version of software (such as an OS, programs of an OS, a driver, and the like, or firmware) from each of the devices included in the diagnostic target system. In a case where the security countermeasure program is installed in the device, the device diagnostic unit 171 further acquires information on the installed security countermeasure program from the device.

The device diagnostic unit 171 further receives information on setting regarding security from each of the devices included in the diagnostic target system. The information on the setting regarding security indicates contents of setting predetermined as the setting regarding security. Examples of the setting regarding security include information on setting of communication filtering, information on setting of access restriction of stored information stored in the device, and information regarding setting of an anti-malware program. The information on the setting regarding security is not limited to these examples.

For the information on vulnerability, the device diagnostic unit 171 extracts vulnerability with reference to the information on vulnerability for each device, the vulnerability for which no countermeasure having been taken in a version of software (or the version of the software and the installed security countermeasure program) acquired from the device.

The device diagnostic unit 171 may acquire information on security states (e.g., existing vulnerability and setting regarding security) of the devices included in the diagnostic target system by being connected to the devices included in the diagnostic target system.

### Information Storage Unit 170

The information storage unit 170 may store the information on the configuration of the diagnostic target system and the information on the states of the devices included in the diagnostic target system. The information on the configuration of the diagnostic target system and the information on the states of the devices included in the diagnostic target system are acquired in advance and stored in the information storage unit 170. The information on the configuration of the diagnostic target system may include at least any one of information representing the configuration of the diagnostic target system, information representing a design of the diagnostic target system, information representing specifications of the diagnostic target system and the devices included in the diagnostic target system, and the like.

The information on the states of the devices includes the information on vulnerability for each device, including information disclosed by a manufacturer of the device. The information on vulnerability for each device may include information on vulnerability disclosed by a security vendor or the like.

The information storage unit 170 stores a countermeasure against vulnerability (in other words, a countermeasure for eliminating the vulnerability, further in other words, a countermeasure for preventing an attack using the vulnerability from being successful) may be stored for each vulnerability for which a countermeasure exists. The countermeasure against the vulnerability may be at least any one of update of software to a version in which the vulnerability has been eliminated, installation of a security countermeasure program for taking a countermeasure against the vulnerability, and change of setting of the device, for example. In other words, the countermeasure can be rephrased as changing a state of the device to prevent an attack on the device capable of being successful from being successful.

The information storage unit 170 may store the information on vulnerability for each type of device.

The information storage unit 170 also stores information on the purpose of the devices included in the diagnostic target system. The information on the purpose of the devices included in the diagnostic target system is also acquired in advance and stored in the information storage unit 170.

The information on the purpose of the devices may include supply chain information on a product whose manufacture is affected by an attack on each device, system requirement information, and the like. Examples of the supply chain information may include business information, usage information, manufacturing information, and legal risk information. Examples of the business information include a name of a product, a sales destination of the product, sales of the product, presence or absence of a substitute product for the product, and a unit price of the substitute product existing. The business information may include information such as a name of a part used for another product in which the product is incorporated, a purchase source of the part, a manufacturer of the part, and the like. The usage information may include information such as a name of another product in which the product is used (in other words, incorporated), a part used for the another product, a sales destination of the another product, sales of the another product, and the like. Examples of the manufacturing information may include a name of a product, another device in which the product is incorporated, a department that manufactures the product, and a contact address of the department (e.g., at least one of an e-mail address and a telephone number).

The legal risk information includes information such as an expected value of the amount of compensation of damage expected to be claimed by a suit in a case where shipment of a product is stopped, an expected value of the amount of compensation of damage expected to be claimed by a suit in a case where shipment of another product in which the product is incorporated is stopped, and the like.

The system requirement information may include information such as a name of a product, a standard to which the product should conform, a criterion for determining that the product conforms to the standard, and means for determining (e.g., a device that performs determination).

The information storage unit 170 preliminarily stores information on rules to be followed by the diagnostic target system. As described above, the rule is at least one of a law and a guideline.

### Model Generation Unit 160

The model generation unit 160 generates a virtual model of the diagnostic target system using the information on the configuration of the diagnostic target system and the information on the states of the devices included in the diagnostic target system. The virtual model simulates operation of the diagnostic target system, the operation being related to security. Examples of the operation related to security include operation in a case where an attack is received.

As described above, the diagnostic parameter generation unit 120 includes the estimation unit 121, the identification unit 122, the item generation unit 123, the requirement generation unit 124, and the information acquisition unit 125. Among them, the estimation unit 121 and the identification unit 122 have functions similar to the functions of the estimation unit 121 and the identification unit 122 of the first example embodiment, respectively. The estimation unit 121 and the identification unit 122 perform operations similar to the operations of the estimation unit 121 and the identification unit 122 of the first example embodiment, respectively.

### Estimation Unit 121

As described above, the estimation unit 121 estimates a management impact, which is a magnitude of influence on revenue loss resulting due to an attack on a device, with reference to the information on the purpose of the devices included in the diagnostic target system.

Specifically, the estimation unit 121 may calculate a total amount of sales of a product whose manufacture is affected by an attack on a device and sales of another product in which the product is incorporated, as a management impact that is a magnitude of influence on revenue loss resulting due to the attack on the device, with reference to the information on the purpose of the devices included in the diagnostic target system. The estimation unit 121 may calculate a total amount of sales of a product whose manufacture is affected by an attack on a device, sales of another product in which the product is incorporated, an estimated value of the amount of compensation of damage due to stoppage of shipment of the product, and an estimated value of the amount of compensation of damage due to stoppage of shipment of the another product, as the management impact, with reference to the information on the purpose of the devices included in the diagnostic target system.

### Identification Unit 122

The identification unit 122 identifies an entry point device capable of being an entry point and an attack target device capable of being a target of the attack among the devices with reference to information on a configuration of the diagnostic target system and the management impact of each of the devices. The description of the present disclosure shows information including a combination of an entry point device and an attack target device that may be referred to as an attack scenario. Specifically, information indicating the entry point device, information indicating the attack target device, and information representing the loss due to an attack on the attack target device, for example, are also referred to as a scenario of attack (in other words, the attack scenario). The identification unit 122 may generate the attack scenario.

### Item Generation Unit 123

The item generation unit 123 generates a diagnostic list of diagnostic items representing information representing an attack capable of being successful for each state, a type of risk caused by the attack, and conditions under which risk for each type occurs, with reference to information indicating contents of vulnerability of the devices.

Examples of the diagnostic items include identification information for identifying a diagnostic item, attack means for attack, attack conditions under which attack is performed (e.g., attack is successful), and information on a type of damage (the risk described above). The examples of the diagnostic items may include information representing whether an attack code already exists, information representing whether operation of simulating vulnerability in a virtual environment is implemented, and information such as presence or absence of an actual example of damage due to an attack. The diagnostic items in the present disclosure may be referred to as diagnostic parameters.

The item generation unit 123 may generate a diagnostic list, which is a list of diagnostic items, using a large language model with reference to the information representing the contents of vulnerability of the devices. In the generation, the item generation unit 123 generates an instruction to generate a diagnostic list. Then, the item generation unit 123 transmits the instruction to generate the diagnostic list and information representing the contents of vulnerability of the devices to the LLM server 200. The item generation unit 123 then receives the diagnostic list from the LLM server 200.

### Requirement Generation Unit 124

The requirement generation unit 124 generates a requirement list, which is a list of requirements to be satisfied by the diagnostic target system, with reference to the information on the rules to be followed by the diagnostic target system. As described above, the rules to be followed by the diagnostic target system are laws, guidelines, and the like.

The requirement generation unit 124 may generate the requirement list using the large language model with reference to the information on the rules to be followed by the diagnostic target system. In the generation, the requirement generation unit 124 generates an instruction to generate the requirement list. Then, the requirement generation unit 124 transmits an instruction to generate the requirement list and the information on the rules to be followed by the diagnostic target system to the LLM server 200. The requirement generation unit 124 then receives the requirement list from the LLM server 200.

The requirement list includes requirements that may be represented by a combination of conditions for information obtained with reference to information on the diagnostic target system and a rule that is violated in a case where the conditions are not satisfied, for example. Examples of the information on the diagnostic target system for the requirements include at least any one of information obtained in a case where an attack route is identified, the information on the states of the devices included in the diagnostic target system, and the information on the configuration of the diagnostic target system.

Examples of the information obtained in a case where the attack route is identified include information on whether information leaks due to an attack in a device holding personal information on a route in which the attack capable of being successful, the route being from the entry point device of the diagnostic target system to any device of the diagnostic target system. Conditions for the information in this example are to satisfy that the information in this example has no possibility. In a case where the conditions are not satisfied in the information, an administrator of the diagnostic target system may violate laws such as the Personal Information Protection Law, for example. That is, examples of the rule violated in the information include a law such as the Personal Information Protection Law.

Examples of the information obtained with reference to the information on the configuration of the diagnostic target system and the information on the states of the devices included in the diagnostic target system include information representing whether a communication network in the diagnostic target system is divided for each security level, and a part with a high security level of the communication network in the diagnostic target system is set to prevent direct access from the outside (e.g., the Internet). Conditions for the information are to satisfy that the communication network in the diagnostic target system is divided for each security level, and a part with a high security level of the communication network in the diagnostic target system is set to prevent direct access from the outside (e.g., the Internet). In a case where the conditions are not satisfied, the diagnostic target system violates a guideline requiring that a network is divided for each security level, and a part of the network with a higher security level is set to prevent direct access from the outside. The rule that is violated in the information is the guideline.

Examples of the information obtained with reference to the information on the configuration of the diagnostic target system and the information on the states of the devices included in the diagnostic target system include information representing whether the network is divided into segments for each security level and access restriction is implemented between the segments. Conditions for the information are to satisfy that the network is divided into segments for each security level, and access restriction is implemented between any two segments. In a case where the conditions are not satisfied, the diagnostic target system may violate a guideline defining a network that is to be divided into segments for each security level and access restriction that is to be implemented between the segments. The rule that is violated in the information is the guideline.

Examples of information obtained with reference to the information on the states of the devices included in the diagnostic target system may include information representing whether vulnerability management is performed. Conditions for the information may be to satisfy that vulnerability of the devices included in the diagnostic target system does not include vulnerability for which a predetermined time has elapsed after a response to the vulnerability is disclosed, for example. In a case where the conditions are not satisfied, the diagnostic target system may violate a guideline defining vulnerability management that is to be implemented. The rule that is violated in the information is the guideline.

Examples of the requirements are not limited to the above. The requirement list may not include at least any one of the requirements described above.

### Information Acquisition Unit 125

The information acquisition unit 125 acquires information on vulnerability, for example. The information acquisition unit 125 may acquire information on vulnerability that is newly disclosed. The information acquisition unit 125 stores the newly acquired information on the vulnerability in the information storage unit 170.

The information acquisition unit 125 may acquire the information on the rules to be followed by the diagnostic target system, for example. In a case where the rules to be followed by the diagnostic target system are updated, the information acquisition unit 125 acquires information on the updated rule. Then, the information acquisition unit 125 updates the information on the rules stored in the information storage unit 170 by applying the acquired information on the rules to the information on the rules stored in the information storage unit 170, for example.

### Detection Unit 130

The detection unit 130 detects an attack route through which the attack from the entry point device to the attack target device is capable of being successful using the information on the configuration of the diagnostic target system, information on states of the devices, and information on an attack capable of being successful for each of the states. The detection unit 130 may detect the attack route using the virtual model as the information on the configuration of the diagnostic target system and the information on the states of the devices of the diagnostic target system. That is, the detection unit 130 detects the attack route through which the attack from the entry point device to the attack target device is capable of being successful using the virtual model and the information on an attack capable of being successful for each state.

As described above, the detection unit 130 detects the attack route through which the attack from the entry point device to the attack target device is capable of being successful using any one of various existing methods. The detection unit 130 may detect the attack route using the technique described in WO 2023/089669 A1, for example. The detection unit 130 (and the detection unit 130 of the first example embodiment) may detect the attack route as follows, for example.

For example, the detection unit 130 determines whether an attack on the attack target device using vulnerability existing in the attack target device is possible with reference to information on a state of the attack target device.

The detection unit 130 may determine whether an attack on a device (an attack target device, an entry point device, and a connectable device below) using vulnerability existing in the device with reference to an item list. Specifically, the detection unit 130 determines whether vulnerability of an item included in the item list exists in the device. In a case where vulnerability of a diagnostic item included in the item list exists in the device, the detection unit 130 determines whether attack conditions of the diagnostic item can be satisfied with reference to information on security setting of the device, for example. In a case where it is determined that the attack conditions are not able to be satisfied, the detection unit 130 determines that the attack using attack means of the diagnostic item is not able to be successful. In a case where it is determined that the attack conditions can be satisfied, the detection unit 130 determines that the attack using the attack means of the diagnostic item can be successful. In this determination, the detection unit 130 determines that a type of damage indicated by a damage type of the diagnostic item can occur in the device.

In a case where an attack using the vulnerability existing in the attack target device is not possible, the detection unit 130 determines that there is no attack route from the entry point device to the attack target device. In a case where the attack using the vulnerability existing in the attack target device is possible, the detection unit 130 may make a determination described below.

The detection unit 130 determines whether an attack on the entry point device can be successful with reference to information on a state of the entry point device. For example, the detection unit 130 determines whether an attack on the entry point device using vulnerability existing in the entry point device is possible in a state of setting of the entry point device. In a case where the attack using the vulnerability existing in the entry point device is possible in the state of the setting of the entry point device, the detection unit 130 determines that the attack on the entry point device can be successful. In a case where the attack using the vulnerability existing in the entry point device is not possible in the state of the setting of the entry point device, the detection unit 130 determines that there is no attack route from the entry point device to the attack target device.

In a case where it is determined that the attack on the entry point device can be successful, the detection unit 130 identifies a device (referred to below as a connectable device) that is communicably connected to the entry point device. In a case where the connectable device is an attack target device, the detection unit 130 identifies a space between the entry point device and the attack target device as an attack route.

In a case where the connectable device is not the attack target device, the detection unit 130 determines whether an attack on the connectable device using vulnerability existing in the connectable device can be successful with reference to information on a state of the connectable device. A method for determining whether the attack on the connectable device can be successful may be similar to a method for determining whether the attack on the entry point device can be successful. In a case where it is determined that an attack on any connectable device can be successful, the detection unit 130 identifies a device that is communicably connected to the any connectable device as a new connectable device, the device being other than the entry point device and not being selected as a connectable device.

In a case where the identified new connectable device is an attack target device, the detection unit 130 identifies a route from the entry point device to the attack target device via a connectable device, for which attack using vulnerability existing in the connectable device is determined to be possible, as an attack route.

In a case where a new connectable device that is not the attack target device is identified, the detection unit 130 similarly determines whether an attack on the new connectable device using vulnerability existing in the new connectable device can be successful with reference to information on a state of the new connectable device. In a case where it is determined that the attack on the new connectable device can be successful, the detection unit 130 identifies a device that is communicably connected to the new connectable device as another new connectable device, the device being other than the entry point device and not being selected as a connectable device.

The detection unit 130 may repeat determination whether the attack on the connectable device using vulnerability existing in the connectable device is successful and identification of the new connectable device until the determination whether the attack on every identified connectable device is successful is completed and a new connectable device is not identified.

In the present disclosure, detecting an attack route from an entry point device to an attack target device is referred to as simulation of an attack (in other words, attack simulation). The detection unit 130 may perform attack simulation using the attack scenario. The attack scenario includes information on the loss due to an attack on the attack target device. In a case where the attack route is detected, the loss due to the attack on the attack target device capable of being attacked through the attack route is also specified.

### Diagnostic Result Estimation Unit 180

The diagnostic result estimation unit 180 estimates a diagnostic result indicating a management impact due to risk (in other words, damage) caused by an attack capable of being successful on the attack target device through the detected attack route with reference to the information on the configuration of the diagnostic target system, the information on the states of the devices, and the diagnostic list. The diagnostic result estimation unit 180 may estimate the diagnostic result using a virtual model of the diagnostic target system as the information on the configuration of the diagnostic target system and the information on the states of the devices. That is, the diagnostic result estimation unit 180 may estimate the diagnostic result indicating the management impact due to the risk (in other words, damage) caused by the attack capable of being successful on the attack target device through the detected attack route using the diagnostic target virtual model and the diagnostic list. As described above, the diagnostic request indicated by the diagnostic instruction received by the instruction receiving unit 110 is a request for diagnosis of the loss, a request for diagnosis of rule violation, or a request for diagnosis of the loss and rule violation, for example.

In a case where the diagnostic request is the request for diagnosis of the loss, the diagnostic result estimation unit 180 estimates the management impact as follows, for example.

In a case where the attack route to the attack target device is detected, an attack on the attack target device through the attack route is determined to be able to be successful. The diagnostic result estimation unit 180 calculates a total amount (i.e., the loss due to the production stoppage described above) of the amount of decrease in sales due to the stoppage of shipment of a product whose manufacture is affected by the attack target device and another product using the product and an expected value of the amount of compensation of damage due to the stoppage of shipment of the product and the another product using the product. The diagnostic result estimation unit 180 may specify the amount of decrease in the sales due to the stoppage of shipment of the product whose manufacture is affected by the attack target device and the another product using the product as the loss due to the production stoppage. The product whose manufacture is affected by the attack target device and the another product using the product are also referred to as products whose shipment is related to the attack target device.

The diagnostic result estimation unit 180 further specifies the loss (i.e., the loss due to the attack described above) estimated in a case where the type of damage indicated by the damage type of the diagnostic item, for which an attack by attack means is determined to be able to be successful, among the diagnostic items included in the diagnostic list occurs in the attack target device, for example. Examples of the type of damage indicated by the damage type of the diagnostic item include information leakage (e.g., leakage of stored information stored in the attack target device). The estimated loss in the information leakage is a total (referred to below also as an estimated loss) of an expected value of the amount of compensation of damage, which is the amount of compensation of damage due to the information leakage, and the amount of decrease in sales caused by decrease in credibility and damage to an image in a case where the information leakage is disclosed, for example. This amount of decrease in sales may not include the amount of decrease in sales due to the stoppage of shipment of the product and the another product using the product.

The diagnostic result estimation unit 180 specifies a total of the loss due to the production stoppage and the loss due to the attack as a magnitude of the management impact. The diagnostic result estimation unit 180 may specify the loss due to the production stoppage and the loss due to the attack as two values each representing the magnitude of the management impact. The diagnostic result estimation unit 180 specifies any one of the loss due to the production stoppage and the loss due to the attack as the magnitude of the management impact.

In a case where the diagnostic request is a request for diagnosis of rule violation, the diagnostic result estimation unit 180 specifies a rule that may be violated as follows, for example.

In a case where an attack on the attack target device capable of being attacked through an identified attack route is successful, the diagnostic result estimation unit 180 identifies a requirement that is not satisfied among the requirements included in the requirement list. Then, the diagnostic result estimation unit 180 identifies a rule that may be violated and that is identified by the requirement that is not satisfied. The diagnostic result estimation unit 180 may identify the rule, which is identified and may be violated, as the management impact.

The diagnostic result estimation unit 180 may further specify the loss in a case where the rule, which may be violated, is violated as the magnitude of the management impact, the loss being determined for each rule in advance in a case where the rule is violated. The loss in a case where the rule is violated is an estimated value of the amount of decrease in sales in a case where the violation of the rule is disclosed. For example, in a case where a range (or the amount of money) of the amount to be paid for violation of a law is defined, the diagnostic result estimation unit 180 may set a total of an estimated value of the amount of decrease in sales in a case where the violation of the rule is disclosed, and an estimated value of the amount to be paid in a case where the law is violated, as the loss in a case where the rule is violated. In a case where there is a product that is not able to be shipped in a case where the rule is violated, the diagnostic result estimation unit 180 may specify the amount of sales of the product that is not able to be shipped due to the violation of the rule that may be violated. Then, the diagnostic result estimation unit 180 may determine a total of the estimated value of the amount of decrease in sales in a case where the violation of the rule is disclosed, the estimated value of the amount to be paid in a case where the law is violated, and the amount of sales of the product that is not able to be shipped due to the violation of the rule that may be violated, as the loss in a case where the rule is violated.

In a case where the diagnostic request is a request for diagnosis of the loss and rule violation, the diagnostic result estimation unit 180 may estimate the management impact described above and identify the rule described above that may be violated. The diagnostic result estimation unit 180 may specify the loss in a case where the rule is violated in identifying the rule that may be violated.

### Countermeasure Identification Unit 181

In a case where the diagnosis request includes a request for diagnosis of the loss, the countermeasure identification unit 181 identifies a countermeasure as follows, for example.

The countermeasure identification unit 181 identifies a countermeasure for changing a state of each of devices included in the attack route from the entry point device to the attack target device to prevent an attack on the attack target device through the attack route from being successful as a countermeasure against the attack on the attack target device by using information on countermeasures stored in the information storage unit 170. The devices included in the attack route are each a device for which an attack on the device is capable of being successful depending on a state of the device.

For the countermeasure, the countermeasure identification unit 181 may identify a countermeasure for each of the devices having countermeasures for changing states of the devices to prevent attacks on the devices from being successful, the devices being included on the attack route to the attack target device. The countermeasure identification unit 181 may identify a countermeasure of a device selected from among the devices having countermeasures for changing states of the devices to prevent attacks on the devices from being successful by using a predetermined selection method, the devices being included on the attack route to the attack target device.

This selection method may be a method for appropriately selecting one or more devices having countermeasures from each attack route to the attack target device, for example. This selection method may be also a method for repeating processing of selecting a device for which a countermeasure exists and through which most attack routes in number pass, the attack routes not passing through a selected device, until an attack route without passing through an unselected device does not exist, for example. In the selection, the countermeasure identification unit 181 identifies a countermeasure of the selected one or more devices as a countermeasure against the attack on the attack target device.

In a case where one device is selected from two or more candidates of devices through each of which attack routes equal in number pass, the countermeasure identification unit 181 may select a device with the smallest load for a countermeasure. A method for calculating a load for the countermeasure may be a method for calculation that is appropriately determined. The method uses any one of the number of security countermeasure programs to be installed, whether a device needs to be stopped in a case where a countermeasure is implemented, and the amount of money necessary for implementing the countermeasure, for example.

In a case where the diagnosis request includes a request for diagnosis of rule violation, the countermeasure identification unit 181 identifies a countermeasure as follows, for example.

In a case where the rule violation is that the diagnostic target system may violate a rule because any device (denoted as factor device) included in the diagnostic target system can be attacked, the countermeasure identification unit 181 identifies a countermeasure that disables attack on the factor device that can be attacked. Conceivable examples of the countermeasure include a countermeasure against violation of a law such as the Personal Information Protection Law due to leakage of personal information caused by an attack on a device that stores the personal information. A method for identifying a countermeasure as described above may be similar to a method for identifying the countermeasure against the attack on the device capable of being attacked described above. For description of the method, the device capable of being attacked described above is replaced with the factor device in the description of identifying the countermeasure against the attack on the device capable of being attacked.

In a case where rule violation is caused by the configuration of the diagnostic target system and setting of the devices included in the diagnostic target system, a countermeasure against the rule violation is changing the setting of the devices included in the diagnostic target system to eliminate possibility of the rule violation, for example. In a case where the possibility of the rule violation is not eliminated only by changing the setting of the devices included in the diagnostic target system, the countermeasure may include a change in the configuration of the diagnostic target system.

For example, an example will be described in which a rule requires that a communication network in a system is divided into segments for each security level, and a part of the communication network in the system with a higher security level is set to prevent direct access from the outside (e.g., the Internet). In this example, the countermeasure identification unit 181 identifies a combination of two devices included in the same segment and being different in security level by using the information on the configuration of the diagnostic target system and the information on the states of the devices included in the diagnostic target system. In a case where a combination as described above is identified, the countermeasure identification unit 181 identifies a countermeasure including dividing the network in the identified combination of the two devices, as a countermeasure in this example. The countermeasure identification unit 181 also identifies a device directly connected to an external network from among devices at a security level equal to or higher than a predetermined level by using the information on the configuration of the diagnostic target system and the information on the states of the devices included in the diagnostic target system. In a case where a device as described above is identified, the countermeasure identification unit 181 identifies a countermeasure including changing setting of the identified device to cut off communication with an external network, as a countermeasure in this example. In a case where the device as described above is identified, the countermeasure identification unit 181 may identify a countermeasure including (e.g., physically) disconnecting a communication network between the identified device and the external network, as a countermeasure in this example.

For example, an example will be described in which a rule requires that a network is divided into segments for each security level and access restriction is implemented between the segments. In this example, the countermeasure identification unit 181 identifies a combination of two devices included in the same segment and being different in security level by using the information on the configuration of the diagnostic target system and the information on the states of the devices included in the diagnostic target system. In a case where a combination as described above is identified, the countermeasure identification unit 181 identifies a countermeasure including dividing the network in the identified combination of the two devices, as a countermeasure in this example. The countermeasure identification unit 181 also identifies a device whose access to a device having a different security level is not restricted by using the information on the configuration of the diagnostic target system and the information on the states of the devices included in the diagnostic target system. In a case where a device as described above is identified, the countermeasure identification unit 181 identifies a countermeasure including changing setting of the identified device to restrict access to a device different in security level, as a countermeasure in this example.

For example, a rule will be described in which vulnerability management is required to be performed in all devices included in a system. For the rule, the countermeasure identification unit 181 identifies a device for which the vulnerability management is not performed by using the information on the states of the devices included in the diagnostic target system. In a case where a device as described above is identified, the countermeasure identification unit 181 identifies a countermeasure including changing setting of the identified device to perform vulnerability management, as a countermeasure for the rule.

### Output Information Generation Unit 182

In a case where a request for diagnosis includes diagnosis of the loss, the output information generation unit 182 generates output information representing a magnitude of business impact due to an attack and an attack target device that can be attacked, for example. The output information generation unit 182 may generate output information listing attack target devices that can be attacked through the attack route detected by the detection unit 130, and that are ranked in descending order of the magnitude of the business impact estimated by the diagnostic result estimation unit 180, for example. The output information is also referred to below as a diagnostic report.

The output information generation unit 182 may generate the output information (i.e., the diagnostic report) using a large language model. For the output information, the output information generation unit 182 specifically transmits an instruction to generate a sentence that explains (in other words, describes) the magnitude of the business impact of the attack and the attack target device that can be attacked, and information representing the magnitude of the business impact of the attack and the attack target device that can be attacked, for example, to the LLM server 200. The LLM server 200 generates the sentence that explains (in other words, describes) the magnitude of the business impact of the attack and the attack target device that can be attacked according to the instruction. The LLM server 200 returns the generated sentence to the output information generation unit 182. The output information generation unit 182 generates a diagnostic report including the generated sentence, which is here the sentence explaining (in other words, describing) the magnitude of the business impact of the attack and the attack target device that can be attacked. The diagnostic report may be described according to a predetermined format.

The output information generation unit 182 may generate output information (i.e., the diagnostic report) further including information representing the countermeasure identified by the countermeasure identification unit 181. The output information generation unit 182 may generate output information (i.e., a diagnostic report) including information representing countermeasures that are ranked in the order of priority set for each of the countermeasures. The order of priority of the countermeasures may be ranked in the order of a magnitude of business impact in a case where an attack is performed on an attack target device that can be attacked by an attack through an attack route that passes through a device on which a countermeasure is taken, for example. For the countermeasures, the number of attack target devices that can be attacked by the attack through the attack route passing through the device on which the countermeasure is taken is not limited to one. The output information generation unit 182 may calculate a statistical value of the magnitude of the business impact in a case where an attack is performed on an attack target device having a countermeasure against the attack and being included in attack target devices that can be attacked by the attack through an attack route passing through a device on which the countermeasure is performed. The statistical value in this calculation is a maximum value or a total value, for example. The output information generation unit 182 may rank the order of priority of the countermeasures in the order of a magnitude of the calculated statistical value.

As described above, the output information generation unit 182 may generate the output information (i.e., the diagnostic report) using a large language model. The output information generation unit 182 may generate information (in other words, a sentence explaining a countermeasure) representing a countermeasure included in the output information (i.e., the diagnostic report) using the large language model. For the output information, the output information generation unit 182 specifically transmits an instruction to generate a sentence explaining (in other words, describing) the countermeasure and information representing the countermeasure, for example, to the LLM server 200. The LLM server 200 generates the sentence explaining (in other words, describing) the countermeasure according to the instruction. The LLM server 200 returns the generated sentence to the output information generation unit 182. The output information generation unit 182 generates a diagnostic report including the generated sentence, which is here the sentence explaining (in other words, describing) the countermeasure. As described above, the diagnostic report may be described according to a predetermined format.

In a case where a request for diagnosis includes diagnosis of rule violation, the output information generation unit 182 generates a diagnostic report including information on a rule that may be violated by the diagnostic target system. Examples of the information on the rule that may be violated by the diagnostic target system include information including information indicating a rule that may be violated by the diagnostic target system and information indicating contents of the violation. The information indicating the contents of the violation may include an event regarded as violation. The information indicating the contents of the violation may include the event including a factor of the violation. Specifically, the event regarded as the violation is leakage of personal information due to an attack on a device that stores the personal information, for example. The factor of the violation in the event may be description of violation of a rule that corresponds to leakage of personal information, for example. Specific examples of the event regarded as violation are not limited to this example.

The event regarded as violation may indicate a part of a rule, the part not being satisfied by the diagnostic target system, and the rule defining the communication network in the system that is divided into segments for each security level, and that includes a part having a high security level and being set to disable direct access from the outside (e.g., the Internet), for example. The event regarded as violation may indicate a part of a rule, the part not being satisfied by the diagnostic target system, and the rule defining the network that is divided into segments for each security level and in which access restriction is implemented between the segments, for example. The event regarded as violation may indicate a part of a rule, the part not being satisfied by the diagnostic target system, and the rule defining vulnerability management that is implemented in all devices included in the system, for example. The violation in each of these events is caused by a factor that may be information representing a device having caused the rule not to be satisfied and setting of the device, for example.

Even for the factor, the output information generation unit 182 may generate the output information (i.e., the diagnostic report) using the large language model. In the generation, the output information generation unit 182 specifically transmits an instruction to generate a sentence explaining (in other words, describing) information on a rule that may be violated by the diagnostic target system and information on the rule that may be violated by the diagnostic target system, for example, to the LLM server 200. The LLM server 200 generates a sentence that explains (in other words, describes) information on a rule that may be violated by the diagnostic target system according to the instruction. The LLM server 200 returns the generated sentence to the output information generation unit 182. The output information generation unit 182 generates a diagnostic report including the generated sentence, which is here the sentence explaining (in other words, describing) the information on the rule that may be violated by the diagnostic target system. The diagnostic report may be described according to a predetermined format.

Even for the diagnostic report, the output information generation unit 182 may generate output information (i.e., the diagnostic report) further including information representing the countermeasure identified by the countermeasure identification unit 181. The output information generation unit 182 may generate output information (i.e., a diagnostic report) including information representing countermeasures that are ranked in the order of priority set for each of the countermeasures. The order of priority of the countermeasures here may be ranked in the order of a magnitude of severity of a rule that is violated in rule violation targeted by each of the countermeasures, for example. The magnitude of the severity here indicates that the rule violation is more serious as a value of the severity of the rule violation increases. The severity of the rule may be determined in advance for each rule. In a case where the countermeasure is against violation of two or more rules, the output information generation unit 182 may rank target violation of rules in order of a magnitude of a statistical value (e.g., a maximum value or a total value) of magnitudes of severity of the two or more rules. The order of priority of countermeasures here may be ranked in the order of a magnitude of business impact of the violation of rules targeted by the countermeasure, for example. In a case where the countermeasure is against violation of two or more rules, the output information generation unit 182 may rank target violation of rules in order of a magnitude of a statistical value (e.g., a maximum value or a total value) of magnitudes of business impact of the two or more rules.

As described above, the output information generation unit 182 may generate the output information (i.e., the diagnostic report) using a large language model. The output information generation unit 182 may generate information (in other words, a sentence explaining a countermeasure) representing a countermeasure included in the output information (i.e., the diagnostic report) using the large language model. For the output information, the output information generation unit 182 specifically transmits an instruction to generate a sentence explaining (in other words, describing) the countermeasure and information representing the countermeasure, for example, to the LLM server 200. The LLM server 200 generates the sentence explaining (in other words, describing) the countermeasure according to the instruction. The LLM server 200 returns the generated sentence to the output information generation unit 182. The output information generation unit 182 generates a diagnostic report including the generated sentence, which is here the sentence explaining (in other words, describing) the countermeasure. As described above, the diagnostic report may be described according to a predetermined format.

The diagnostic report has a sentence of a part describing an attack target device that can be attacked and business impact caused by an attack on the attack target device, the sentence being referred to as an influence explanatory sentence. The diagnostic report has a sentence of a part describing rule violation, rule violation and its severity, or rule violation and its business impact, the sentence being also referred to as an influence explanatory sentence. The diagnostic report has also a sentence of a part describing a countermeasure, the sentence being referred to as a countermeasure explanatory sentence.

### Output Unit 140

The output unit 140 outputs information on a diagnostic result indicating the management impact due to the attack on the attack target device through the detected attack route. Specifically, the output unit 140 may output the output information (i.e., the diagnostic report described above) generated by the output information generation unit 182 as the information on a diagnostic result. The output unit 140 outputs a diagnostic result (specifically, information on the diagnostic result) including the influence explanatory sentence and the countermeasure explanatory sentence, for example. An output destination of the output unit 140 is the terminal device 400, for example. In other words, the output unit 140 outputs the diagnostic result to the terminal device 400.

The diagnostic device 100 may operate as the terminal device 400. The output destination of the output unit 140 here may be an output device such as a display of the diagnostic device 100, for example. The output unit 140 may output the diagnostic result to the output device such as the display of the diagnostic device 100.

The output unit 140 may output the diagnostic result to any one of other information processing devices, storage devices, and the like communicably connected to the diagnostic device 100.

The output unit 140 may output the diagnostic result as data in a format that can be displayed on a screen. The output unit 140 may output the diagnostic result as a file of a predetermined format. The output unit 140 may output the diagnostic result as data in a format that can be displayed on a screen and a file in a predetermined format.

### Operation

Next, an operation of the second example embodiment of the present disclosure will be described in detail by using the drawings.

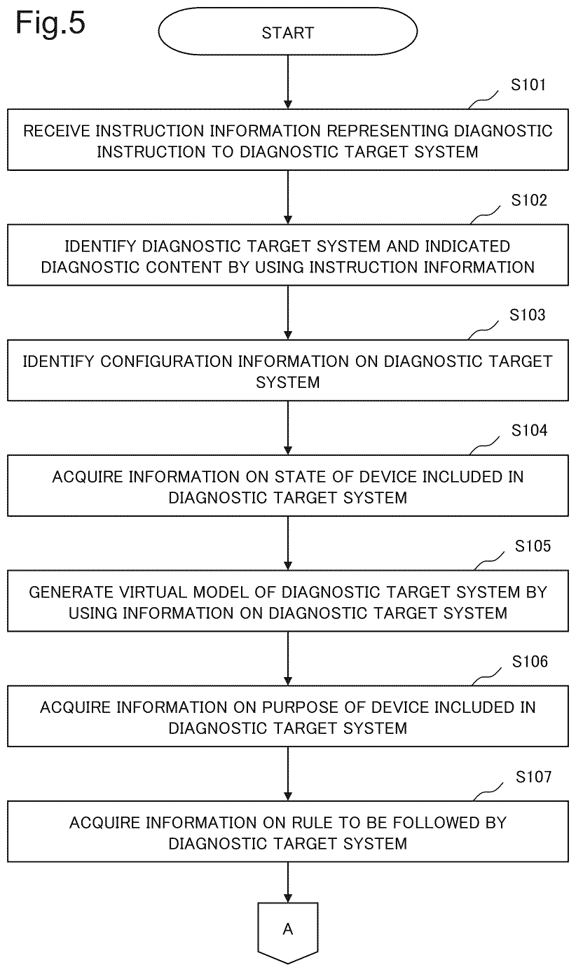

FIGS. 5 to 8 are each a flowchart illustrating an example of operation of the diagnostic device according to the present disclosure.

Hereinafter, an example of operation of the diagnostic device according to the second example embodiment of the present disclosure will be described in detail by using FIGS. 5 to 8.

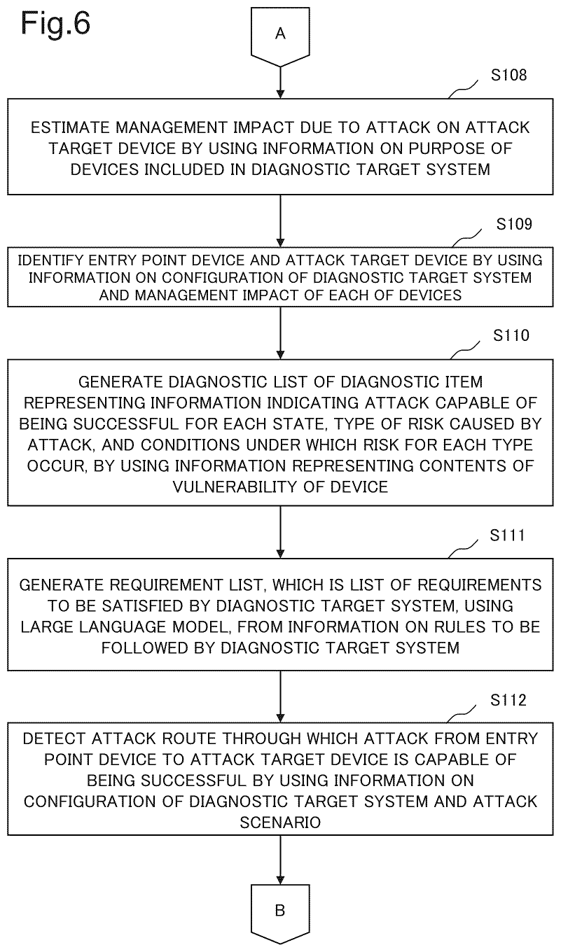

FIG. 5 illustrates an example in which the instruction receiving unit 110 receives instruction information representing an instruction of diagnosis for the diagnostic target system (step S101). Next, the instruction receiving unit 110 identifies the diagnostic target system and contents of the instructed diagnosis by using the instruction information, for example (step S102). Next, the procedure control unit 150 identifies information on the configuration of the diagnostic target system, for example (step S103). Next, the device diagnostic unit 171 acquires information on the states of the devices included in the diagnostic target system (step S104). Next, the model generation unit 160 generates a virtual model of the diagnostic target system by using the information on the diagnostic target system (step S105). Next, the information acquisition unit 125 acquires the information on the purpose of the devices included in the diagnostic target system, for example (step S106). In a case where the information on the purpose of the devices is stored in the information storage unit 170, the information acquisition unit 125 reads the information on the purpose of the devices from the information storage unit 170. In a case where the information on the purpose of the devices is not stored in the information storage unit 170, the information acquisition unit 125 acquires the information on the purpose of the devices from a server or the like holding the information on the purpose of the devices. Next, the information acquisition unit 125 acquires the information on the rules to be followed by the diagnostic target system, for example (step S107). In a case where the information on the rules to be followed by the diagnostic target system is stored in the information storage unit 170, the information acquisition unit 125 reads the information on the rules to be followed by the diagnostic target system from the information storage unit 170. In a case where the information storage unit 170 does not store the information on the rules to be followed by the diagnostic target system, the information acquisition unit 125 acquires the information on the rules to be followed by the diagnostic target system from a server or the like holding the information on the rules to be followed by the diagnostic target system. The rules to be followed by the diagnostic target system may be determined in advance for each diagnostic system. Next, the diagnostic device 100 performs operation illustrated in FIG. 6.

FIG. 6 illustrates an example in which the estimation unit 121 first estimates management impact due to an attack on an attack target device by using the information on the purpose of the devices included in the diagnostic target system (step S108). Next, the identification unit 122 identifies an entry point device and the attack target device by using the information on the configuration of the diagnostic target system and the management impact of each of the devices (step S109). Next, the item generation unit 123 generates a diagnostic list of diagnostic items representing information representing an attack capable of being successful for each state, a type of risk caused by the attack, and conditions under which risk for each type occurs, by using information indicating contents of the vulnerability of the devices (step S110). Next, the requirement generation unit 124 generates a requirement list, which is a list of requirements to be satisfied by the diagnostic target system, using the large language model, by using the information on the rules to be followed by the diagnostic target system (step S111).

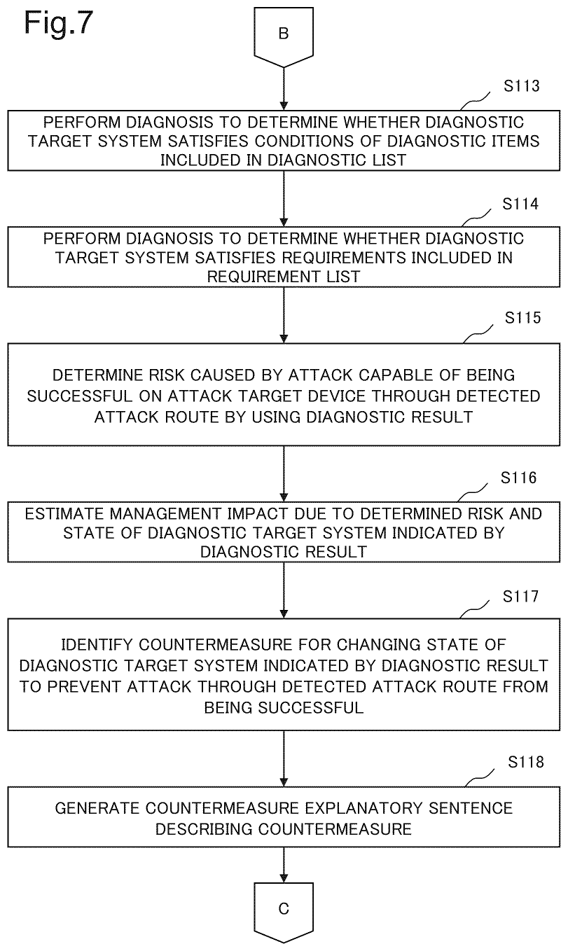

Then, the detection unit 130 detects an attack route through which an attack from the entry point device to the attack target device is capable of being successful by using the information on the configuration of the diagnostic target system and the attack scenario (step S112). Next, the diagnostic device 100 performs operation illustrated in FIG. 7.

FIG. 7 illustrates an example in which the diagnostic result estimation unit 180 performs diagnosis to determine whether the diagnostic target system satisfies the conditions of the diagnostic items included in the diagnostic list (step S113). The diagnostic result estimation unit 180 further performs diagnosis to determine whether the diagnostic target system satisfies the requirements included in the requirement list (step S114). The diagnostic result estimation unit 180 determines a risk caused by an attack capable of being successful on the attack target device through the detected attack route by using the diagnostic results obtained in step S113 and step S114 (step S115). This risk can also be rephrased as the damage described above. The diagnostic result estimation unit 180 estimates the management impact due to the determined risk and a state of the diagnostic target system indicated by the diagnostic result (step S116). In step S116, the diagnostic result estimation unit 180 estimates the management impact caused by the attack on the attack target device that can be attacked through the detected attack route, and the management impact caused by rule violation caused by the attack capable of being successful and rule violation in the state of the diagnostic target system.

Next, the countermeasure identification unit 181 identifies a countermeasure for changing the state of the diagnostic target system indicated by the diagnostic result to prevent the attack through the detected attack route from being successful (step S117).

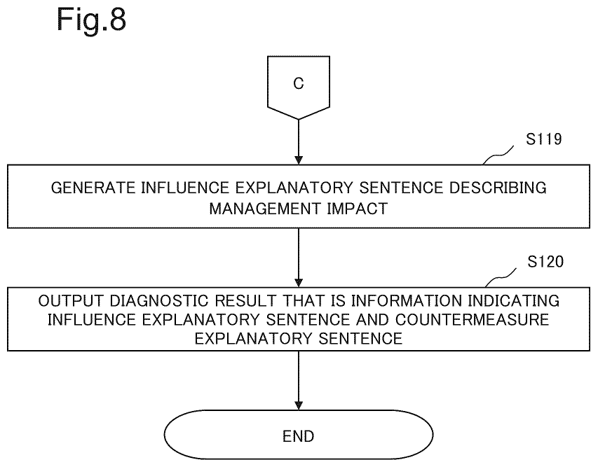

Next, the output information generation unit 182 generates a countermeasure explanatory sentence describing the countermeasure (step S118). Next, the diagnostic device 100 performs operation illustrated in FIG. 8.

FIG. 8 illustrates an example in which the output information generation unit 182 generates an influence explanatory sentence describing the management impact (step S119). The diagnostic device 100 may perform the operation of step S118 of FIG. 7 after the operation of step S119 of FIG. 8.

Then, the output unit 140 outputs a diagnostic result that is information indicating the influence explanatory sentence and the countermeasure explanatory sentence (step S120).

### Effects

The present example embodiment described above has the same effect as the effect of the first example embodiment. The effect is achieved by the reason same as the reason why the effect of the first example embodiment is achieved.

### Modification of Second Example Embodiment

Next, a modification of the second example embodiment of the present disclosure will be described in detail by using the drawings.

### Configuration

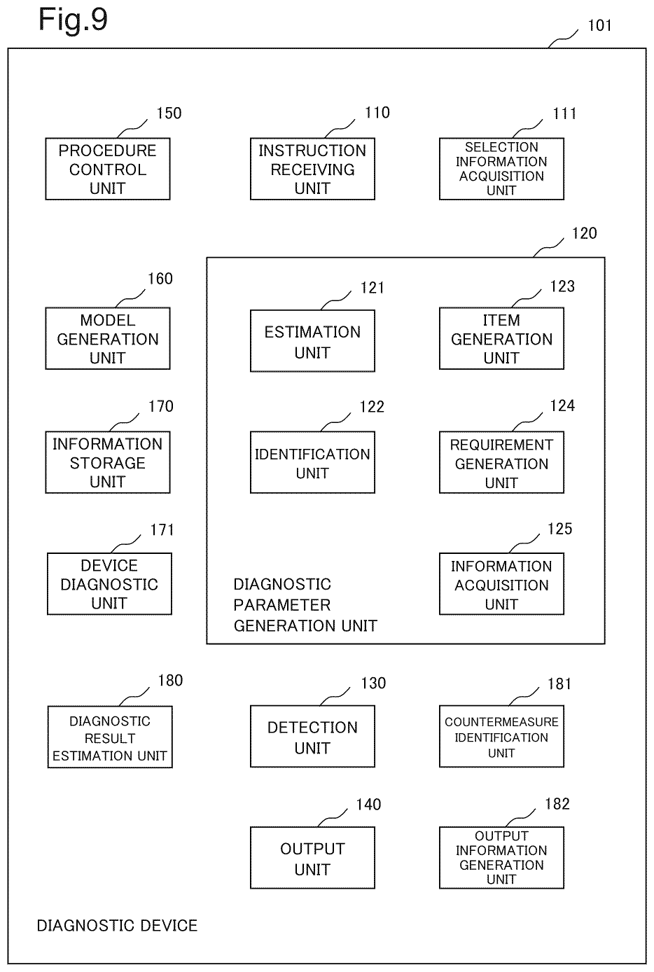

FIG. 9 is a block diagram illustrating an example of the configuration of the diagnostic device according to the present disclosure.

Hereinafter, the diagnostic device according to the modification of the second example embodiment of the present disclosure will be described in detail by using FIG. 9.

FIG. 9 illustrates a diagnostic device 101 that includes a selection information acquisition unit 111 in addition to the components of the diagnostic device 100 illustrated in FIG. 4. The diagnostic device 101 illustrated in FIG. 9 includes components that are the same as the components with the same names and the same reference numerals of the diagnostic device 100 illustrated in FIG. 4, except for differences described below.

### Output Information Generation Unit 182

The output information generation unit 182 of the present modification generates a screen representing the configuration of the diagnostic target system, such as a screen including a display representing devices included in the diagnostic target system and a display representing a connection between the devices included in the diagnostic target system. The display representing the devices included in the diagnostic target system is represented by at least one of figures and characters indicating the respective devices, for example. The display representing the connection between the devices included in the diagnostic target system is represented by a line connecting between displays representing the devices, for example. This screen may display an attack target device in a mode different from that for a display indicating a device that is not the attack target device. Examples of the display mode representing the device include color, pattern, line thickness, and line type.

### Output Unit 140

The output unit 140 of the present modification outputs not only information on a diagnostic result but also the screen generated by the output information generation unit 182 to an information processing device (e.g., the terminal device 400) as an output destination. The output unit 140 of the present modification may output the screen as the diagnostic result generated by the output information generation unit 182 to the information processing device (e.g., the terminal device 400) as the output destination.

### Selection Information Acquisition Unit 111

The selection information acquisition unit 111 receives selection information on the screen output by the output unit 140, the selection information indicating an attack target device designated using an input device such as a mouse or a touch panel of the information processing device (e.g., the terminal device 400) as the output destination of the screen.

In a case where the selection information acquisition unit 111 acquires the selection information indicating the selected attack target device, the procedure control unit 150 may transmit an instruction to generate output information to the output information generation unit 182, the output information superimposing a display representing a management impact in a case where an attack on the selected attack target device is successful.

In response to receiving the selection information, the output information generation unit 182 generates the above-described screen representing the configuration of the diagnostic target system while superimposing the information on the management impact due to an attack on the attack target device indicated by the selection information on the screen. In other words, the output information generation unit 182 updates the screen to superimpose the information on the management impact due to the attack on the attack target device indicated by the selection information on the screen.

The output unit 140 outputs the updated screen to the information processing device (e.g., the terminal device 400) as the output destination.

### Operation

FIGS. 5 to 7, and 10 are each a flowchart illustrating an example of operation of the diagnostic device according to the present disclosure.

Hereinafter, operation of the diagnostic device according to the modification of the second example embodiment of the present disclosure will be described in detail by using FIGS. 5 to 7, and 10.

The operation of the diagnostic device 101 of the present modification from FIG. 5 to FIG. 7 is the same as the operation of the diagnostic device 100 of the second example embodiment from FIG. 5 to FIG. 7, respectively.

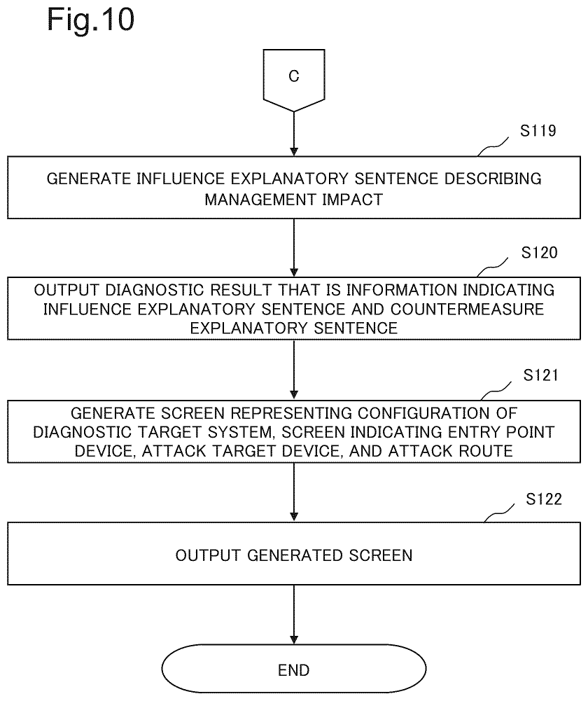

The operation in step S119 and step S120 in FIG. 10 of the present modification are the same as the operation in step S119 and step S120 of the diagnostic device 100 of the second example embodiment illustrated in FIG. 8, respectively. In step S120, the output unit 140 may output a diagnostic result as a file of a predetermined format. The output unit 140 may not perform the operation in step S120.

After the operation in step S120, the output information generation unit 182 generates a screen representing the configuration of the diagnostic target system, the screen indicating the entry point device, the attack target device, and the attack route (step S121). Next, the output unit 140 outputs the generated screen (step S122).

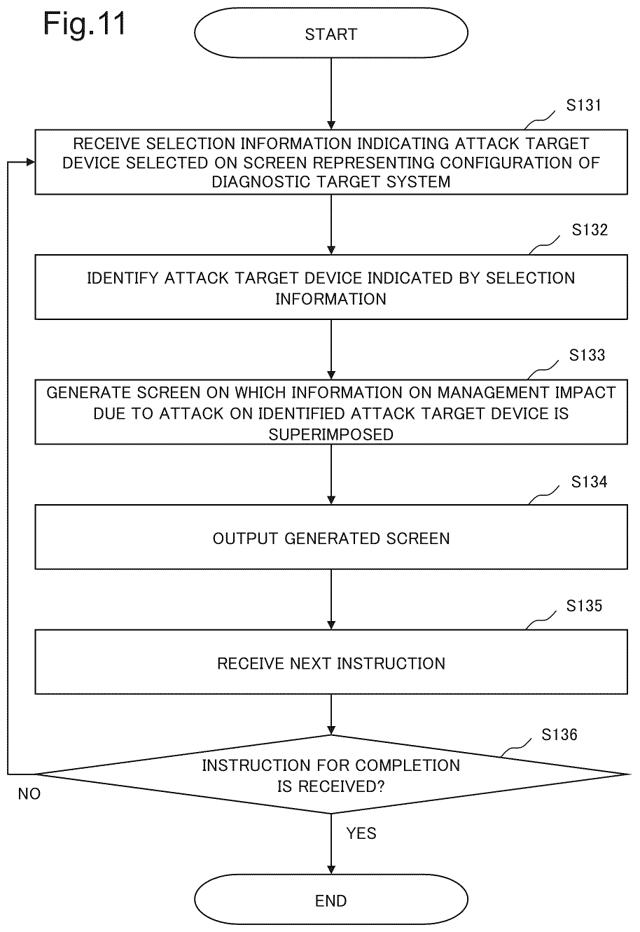

FIG. 11 is a flowchart illustrating an example of operation of the diagnostic device according to the present disclosure in a case where the selection information is received.

Hereinafter, operation of the diagnostic device according to the modification of the second example embodiment of the present disclosure in a case where the selection information is received will be described in detail by using FIG. 11. The diagnostic device 101 of the present modification performs the operation illustrated in FIG. 11 after the operation in step S122 illustrated in FIG. 10.

FIG. 11 illustrates an example in which the selection information acquisition unit 111 receives the selection information indicating the attack target device selected on the screen representing the configuration of the diagnostic target system (step S131). The selection information acquisition unit 111 identifies the attack target device indicated by the selection information (step S132).

The output information generation unit 182 generates a screen on which information on the management impact due to the attack on the identified attack target device is superimposed (step S133).

The output unit 140 outputs the generated screen (step S134).

Next, the selection information acquisition unit 111 receives a next instruction, for example (step S135). The next instruction is an instruction for completion or selection information, for example. In a case where the instruction for completion is not received (NO in step S136), the diagnostic device 101 repeats the operation in and after step S131.

In a case where the instruction for completion is received (YES in step S136), the diagnostic device 101 ends the operation illustrated in FIG. 11.

### Other Example Embodiments

The diagnostic device according to the present disclosure can be implemented by a computer including a memory in which a program read from a storage medium is loaded and a processor that executes the program. The diagnostic device according to the present disclosure can also be implemented by dedicated hardware. The diagnostic device according to the present disclosure can also be implemented by a combination of the above-described computer and dedicated hardware.

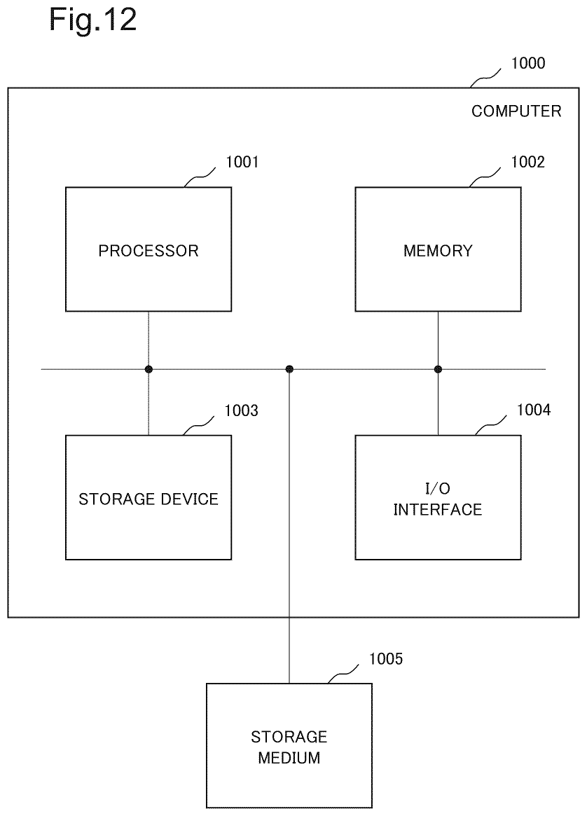

FIG. 12 is a diagram illustrating an example of a hardware configuration of a computer 1000 capable of implementing the diagnostic device according to the present disclosure. FIG. 12 illustrates the example in which the computer 1000 includes a processor 1001, a memory 1002, a storage device 1003, and an input/output (I/O) interface 1004. The computer 1000 can access a storage medium 1005. The memory 1002 and the storage device 1003 are storage devices such as a random access memory (RAM) and a hard disk, respectively, for example. Examples of the storage medium 1005 include a RAM, a storage device such as a hard disk, a read only memory (ROM), and a portable storage medium. The storage device 1003 may be the storage medium 1005. The processor 1001 can read and write data and programs from and to the memory 1002 and the storage device 1003. The processor 1001 can access the LLM server 200 or the like using the I/O interface 1004, for example. The processor 1001 can access the storage medium 1005. The storage medium 1005 stores a program for causing the computer 1000 to operate as the diagnostic device according to the present disclosure.

The processor 1001 loads a program stored in the storage medium 1005 into the memory 1002, the program causing the computer 1000 to operate as the diagnostic device according to the present disclosure. Then, the processor 1001 executes the program loaded in the memory 1002 to cause the computer 1000 to operate as the diagnostic device according to the present disclosure.

The instruction reception unit 110, the selection information acquisition unit 111, the diagnostic parameter generation unit 120, the detection unit 130, the output unit 140, the procedure control unit 150, the model generation unit 160, the device diagnostic unit 171, the diagnostic result estimation unit 180, the countermeasure identification unit 181, and the output information generation unit 182 can be implemented by the processor 1001 that executes the program loaded in the memory 1002, for example. The estimation unit 121, the identification unit 122, the item generation unit 123, the requirement generation unit 124, and the information acquisition unit 125 can be implemented by the processor 1001 that executes the program loaded in the memory 1002, for example. The information storage unit 170 can be implemented by the memory 1002 provided in the computer 1000 or the storage device 1003 such as a hard disk device. Some or all of the instruction reception unit 110, the selection information acquisition unit 111, the diagnostic parameter generation unit 120, the detection unit 130, the output unit 140, the procedure control unit 150, the model generation unit 160, the information storage unit 170, the device diagnostic unit 171, the diagnostic result estimation unit 180, the countermeasure identification unit 181, and the output information generation unit 182 can be implemented by a dedicated circuit that implements the function of each unit. Some or all of the estimation unit 121, the identification unit 122, the item generation unit 123, the requirement generation unit 124, and the information acquisition unit 125 can be implemented by a dedicated circuit that implements the function of each unit.

Some or all of the above example embodiments may be described as the following Supplementary Notes, but are not limited to the following.

### Supplementary Note 1

A diagnostic device including:
an estimation unit that estimates a management impact that is a magnitude of influence on revenue loss resulting due to an attack on a device included in a diagnostic target system by using information on a purpose of the devices;
an identification unit that identifies an entry point device and an attack target device in the devices by using information on a configuration of the diagnostic target system and the management impact the device, the entry point device being capable of being caused to be an entry point, the attack target device being capable of being caused to be a target of the attack;
a detection unit that detects an attack route through which the attack from the entry point device to the attack target device is capable of being successful by using information on the configuration of the diagnostic target system, information on a state of the device, and information on an attack capable of being successful in the state; and
an output unit that outputs information on a diagnostic result indicating the management impact due to the attack on the attack target device through the detected attack route.

### Supplementary Note 2

The diagnostic device described in Supplementary Note 1, in which
the output unit outputs information on the diagnostic result including information on the attack route.

### Supplementary Note 3

The diagnostic device described in Supplementary Note 1 or 2, in which
the state of the device include a state of vulnerability of the device and a state of setting of the device,
the diagnostic device further including item generation unit that generates a diagnostic list based on information representing contents of the vulnerability of the device, the diagnostic list being a list of diagnostic items representing information indicating an attack capable of being successful in the state, a type of risk caused by the attack, and a condition under which the risk of the type occurs,
in which the detection unit detects the attack route by using the state of the devices and the diagnostic list, and
the diagnostic device further including:
a diagnostic result estimation unit that estimates, by using the diagnostic list, the diagnostic result indicating the management impact due to the risk caused by the attack in a case where the attack become successful on the attack target device through the detected attack route.

### Supplementary Note 4

The diagnostic device described in Supplementary Note 1 or 2, in which
the output unit outputs a screen representing the configuration of the diagnostic target system in which the entry point device and the attack target device are indicated, and
the diagnostic device further including a selection information acquisition unit for acquiring selection information indicating the attack target device selected on the screen,
in which the output unit outputs the screen on which impact information is superimposed, the impact information being information on the management impact due to an attack on the attack target device indicated by the selection information.

### Supplementary Note 5

The diagnostic device described in Supplementary Note 1 or 2, in which
the detection unit detects the attack route by performing a simulation of an attack from the entry point device to the attack target device by using the information on the configuration of the diagnostic target system.

### Supplementary Note 6

The diagnostic device described in Supplementary Note 1 or 2, further including:
instruction receiving unit for receiving an instruction on contents of the management impact,
in which the estimation unit estimates the management impact of the contents.

### Supplementary Note 7

The diagnostic device described in Supplementary Note 6, in which
the instruction on the contents includes a loss,
the information on the purpose of the devices includes a product whose shipment is related to the device and information on sales of the product, and
the estimation unit estimates, in a case where the instruction on the contents includes the loss, the management impact including a magnitude of the amount of decrease in sales of the product whose shipment is related to the attack target device as the management impact.

### Supplementary Note 8

The diagnostic device described in Supplementary Note 6, in which
the instruction on the contents includes the loss,
the information on the purpose of the device includes information on stored information that is information stored in the device and information on an estimated loss due to leakage of the stored information in a case where the stored information is leaked, and
the estimation unit estimates the management impact including a magnitude of the estimated loss due to the leakage of the stored information in a case where the stored information in the attack target device is leaked due to an attack on the attack target device, as the management impact in a case where the instruction on the contents is the loss.

### Supplementary Note 9

The diagnostic device described in Supplementary Note 6, in which
the instruction on the contents includes rule violation, and
the estimation unit estimates the management impact including information on a rule that is violated in the state of the device of the diagnostic target system among one or more rules to be followed by the diagnostic target system, as the management impact in a case where the instruction on the contents is the rule violation.

### Supplementary Note 10

The diagnostic device described in Supplementary Note 9, in which
the information on the purpose of the devices includes information on stored information that is stored in each of the devices, and
the estimation unit estimates the management impact including the information on the rule that is violated in a case where the stored information on the attack target device is leaked due to an attack on the attack target device.

### Supplementary Note 11

The diagnostic device described in Supplementary Note 9, further including:
a requirement generation unit that generates a list of requirements to be satisfied by the diagnostic target system by using a large language model, from information on the rules to be followed by the diagnostic target system,
in which the estimation unit estimates whether the requirements included in the list are satisfied by using the configuration of the diagnostic target system and the state of the device, and estimates the rule that is violated by using information on an unsatisfied requirement among the requirements.

### Supplementary Note 12

The diagnostic device described in Supplementary Note 1 or 2, further including:
a model generation unit that generates a virtual model representing the diagnostic target system by using the information on the configuration of the diagnostic target system and information on the devices,
in which the estimation unit estimates the diagnostic result by using the virtual model.

### Supplementary Note 13

The diagnostic device described in Supplementary Note 1 or 2, further including:
an output information generation unit that generates a result explanatory sentence that is a sentence describing the diagnostic result from the diagnostic result by using a large language model,
in which the output unit outputs information on the diagnostic result including the result explanatory sentence.

### Supplementary Note 14

The diagnostic device described in Supplementary Note 13, further including:
A countermeasure identification unit that identifies, as a countermeasure for the attack target device, a countermeasure for changing the state of the device included in the attack route to the attack target device in such a way to prevent an attack on the attack target device through the attack route from being successful by using information on a countermeasure for changing the state to prevent an attack on the device capable of being successful in the state from being successful,
in which the output information generation unit generates a countermeasure explanatory sentence describing the countermeasure for the attack target device using the large language model, and
the output unit outputs information on the diagnostic result further including the countermeasure explanatory sentence of the countermeasure for the attack target device in order of magnitude of the management impact in a case where the attack target device is attacked.

### Supplementary Note 15

A diagnostic method including:
estimating a management impact that is a magnitude of an influence on management due to an attack on a device included in a diagnostic target system based on information on a purpose of the device;
identifying an entry point device and an attack target device in the device by using information on a configuration of the diagnostic target system and the management impact of the device, the entry point device being a device capable of being caused to be an entry point, the attack target device being a device capable of being caused to be a target of the attack;
detecting an attack route through which the attack from the entry point device to the attack target device is capable of being successful by using information on the configuration of the diagnostic target system, information on state of the device, and information on an attack capable of being successful in the state; and
outputting information on a diagnostic result indicating the management impact due to the attack on the attack target device through the detected attack route.

### Supplementary Note 16

The diagnostic method described in Supplementary Note 15, further including:
outputting information on the diagnostic result including information on the attack route.

### Supplementary Note 17

The diagnostic method described in Supplementary Note 15 or 16, in which
the state of the device include a state of vulnerability of the device and a state of setting of the device, and
the diagnostic method further including:
generating a diagnostic list based on information representing contents of the vulnerability of the device, the diagnostic list being a list of diagnostic items representing information indicating an attack capable of being successful in the state, a type of risk caused by the attack, and a condition under which the risk of the type occurs,
detecting the attack route by using the state of the device and the diagnostic list, and
estimating, by using the diagnostic list, the diagnostic result indicating the management impact due to the risk caused by the attack in a case where the attack become successful on the attack target device through the detected attack route.

### Supplementary Note 18

The diagnostic method described in Supplementary Note 15 or 16, further including:
outputting a screen representing the configuration of the diagnostic target system in which the entry point device and the attack target device are indicated;
acquiring selection information indicating the attack target device selected on the screen; and
outputting the screen on which impact information is superimposed, the impact information being information on the management impact due to an attack on the attack target device indicated by the selection information.

### Supplementary Note 19

The diagnostic method described in Supplementary Note 15 or 16, further including:
detecting the attack route by performing a simulation of an attack from the entry point device to the attack target device by using the information on the configuration of the diagnostic target system.

### Supplementary Note 20

The diagnostic method described in Supplementary Note 15 or 16, further including:
receiving an instruction on contents of the management impact; and
estimating the management impact of the contents.

### Supplementary Note 21

The diagnostic method described in Supplementary Note 20, in which
the instruction on the contents includes a loss,
the information on the purpose of the device includes a product whose shipment is related to the device and information on sales of the product, and
the diagnostic method further including:
estimating, in a case where the instruction on the contents includes the loss, the management impact including a magnitude of the amount of decrease in sales of the product whose shipment is related to the attack target device as the management impact.

### Supplementary Note 22

The diagnostic method described in Supplementary Note 20, in which
the instruction on the contents includes the loss,
the information on the purpose of the devices includes information on stored information that is stored in the device and information on an estimated loss due to leakage of the stored information in a case where the stored information is leaked, and
the diagnostic method further including:
estimating the management impact including a magnitude of the estimated loss due to the leakage of the stored information in a case where the stored information in the attack target device is leaked due to an attack on the attack target device, as the management impact in a case where the instruction on the contents is the loss.

### Supplementary Note 23

The diagnostic method described in Supplementary Note 20, in which
the instruction on the contents includes rule violation, and
the diagnostic method further including:
estimating the management impact including information on a rule that is violated in the state of corresponding one of the devices of the diagnostic target system among one or more rules to be followed by the diagnostic target system, as the management impact in a case where the instruction on the contents is the rule violation.

### Supplementary Note 24

The diagnostic method described in Supplementary Note 23, in which
the information on the purpose of the devices includes information on stored information that is information stored in the device, and
the diagnostic method further including:
estimating the management impact including the information on the rule that is violated in a case where the stored information on the attack target device is leaked due to an attack on the attack target device.

### Supplementary Note 25

The diagnostic method described in Supplementary Note 23, further including:
generating a list of requirements to be satisfied by the diagnostic target system, by using a large language model, from information on the rules to be followed by the diagnostic target system;
estimating whether the requirements included in the list are satisfied by using the configuration of the diagnostic target system and the state of the device; and
estimating the rule that is violated by using information on an unsatisfied requirement among the requirements.

### Supplementary Note 26

The diagnostic method described in Supplementary Note 15 or 16, further including:
generating a virtual model representing the diagnostic target system by using the information on the configuration of the diagnostic target system and information on the devices; and
estimating the diagnostic result by using the virtual model.

### Supplementary Note 27

The diagnostic method described in Supplementary Note 15 or 16, further including:
generating a result explanatory sentence that is a sentence describing the diagnostic result from the diagnostic result by using a large language model; and
outputting information on the diagnostic result including the result explanatory sentence.

### Supplementary Note 28

The diagnostic method described in Supplementary Note 27, further including:
identifying, as a countermeasure for the attack target device, a countermeasure for changing the state of the device included in the attack route to the attack target device in such a way to prevent an attack on the attack target device through the attack route from being successful by using information on a countermeasure for changing the state to prevent an attack on the device capable of being successful in the state from being successful;
generating a countermeasure explanatory sentence describing the countermeasure for the attack target device by using the large language model; and
outputting information on the diagnostic result further including the countermeasure explanatory sentence of the countermeasure for the attack target device in order of magnitude of the management impact in a case where the attack target device is attacked.

### Supplementary Note 29

A program that causes a computer to perform processing, the processing including:
estimation processing of estimating a management impact that is a magnitude of an influence on management due to an attack on a device included in a diagnostic target system based on information on a purpose of the devices;
identification processing of identifying an entry point device and an attack target device in the device by using information on a configuration of the diagnostic target system and the management impact of the device, the entry point device being a device capable of being caused to be an entry point, the attack target device being a device capable of being caused to be a target of the attack;
detection processing of detecting an attack route through which the attack from the entry point device to the attack target device is capable of being successful by using the information on the configuration of the diagnostic target system, information on a state of the device, and information on an attack capable of being successful in the state; and
output processing of outputting information on a diagnostic result indicating the management impact due to the attack on the attack target device through the detected attack route.

### Supplementary Note 30

The program described in Supplementary Note 29, in which
the output processing is performed to output information on the diagnostic result including information on the attack route.

### Supplementary Note 31

The program described in Supplementary Note 29 or 30, in which
the state of the device include a state of vulnerability of the device and a state of setting of the device,
the program causes the computer to perform item generation processing of generating a diagnostic list based on information representing contents of the vulnerability of the device, the diagnostic list being a list of diagnostic items representing information indicating an attack capable of being successful in the state, a type of risk caused by the attack, and a condition under which the risk of the type occurs,
the detection processing is performed to detect the attack route by using the states of the devices and the diagnostic list, and
the program causes the computer to perform
diagnostic result estimation processing of estimating, by using the diagnostic list, the diagnostic result indicating the management impact due to the risk caused by the attack in a case where the attack become successful on the attack target device through the detected attack route.

### Supplementary Note 32

The program described in Supplementary Note 29 or 30, in which
the output processing is performed to output a screen representing the configuration of the diagnostic target system in which the entry point device and the attack target device are indicated,
the program causes the computer to perform selection information acquisition processing of acquiring selection information indicating the attack target device selected on the screen, and
the output processing is performed to output the screen on which impact information is superimposed, the impact information being information on the management impact due to an attack on the attack target device indicated by the selection information.

### Supplementary Note 33

The program described in Supplementary Note 29 or 30, in which
the detection processing is performed to detect the attack route by performing a simulation of an attack from the entry point device to the attack target device by using the information on the configuration of the diagnostic target system.

### Supplementary Note 34

The program described in Supplementary Note 29 or 30, in which
the program causes the computer to perform
instruction receiving processing of receiving an instruction on contents of the management impact, and
the estimation processing is performed to estimate the management impact of the contents.

### Supplementary Note 35

The program described in Supplementary Note 34, in which
the instruction on the contents includes a loss,
the information on the purpose of the devices includes a product whose shipment is related to the device and information on sales of the product, and
the estimation processing is performed to estimate, in a case where the instruction on the contents includes the loss, the management impact including a magnitude of the amount of decrease in sales of the product whose shipment is related to the attack target device as the management impact.

### Supplementary Note 36

The program described in Supplementary Note 34, in which
the instruction on the contents includes the loss,
the information on the purpose of the devices includes information on stored information that is stored in the device and information on an estimated loss due to leakage of the stored information in a case where the stored information is leaked, and
the estimation processing is performed to estimate the management impact including a magnitude of the estimated loss due to the leakage of the stored information in a case where the stored information in the attack target device is leaked due to an attack on the attack target device, as the management impact in a case where the instruction on the contents is the loss.

### Supplementary Note 37

The program described in Supplementary Note 34, in which
the instruction on the contents includes rule violation, and
the estimation processing is performed to estimate the management impact including information on a rule that is violated in the states of the device of the diagnostic target system among one or more rules to be followed by the diagnostic target system, as the management impact in a case where the instruction on the contents is the rule violation.

### Supplementary Note 38

The program described in Supplementary Note 37, in which
the information on purpose of the devices includes information on stored information that is information stored in the device, and
the estimation processing is performed to estimate the management impact including the information on the rule that is violated in a case where the stored information on the attack target device is leaked due to an attack on the attack target device.

### Supplementary Note 39

The program described in Supplementary Note 37, in which
the program causes the computer to perform
requirement generation processing of generating a list of requirements to be satisfied by the diagnostic target system, by using a large language model from information on the rules to be followed by the diagnostic target system, and
the estimation processing is performed to estimate whether the requirements included in the list are satisfied by using the configuration of the diagnostic target system and the states of the devices, and estimates the rule that is violated by using information on an unsatisfied requirement among the requirements.

### Supplementary Note 40

The program described in Supplementary Note 29 or 30, in which
the program causes the computer to perform
model generation processing of generating a virtual model representing the diagnostic target system by using the information on the configuration of the diagnostic target system and information on the devices, and
the estimation processing is performed to estimate the diagnostic result using the virtual model.

### Supplementary Note 41

The program described in Supplementary Note 29 or 30, in which
the computer is caused to perform output information generation processing of generating a result explanatory sentence that is a sentence describing the diagnostic result by using the diagnostic result by using a large language model, and
the output processing is performed to output information on the diagnostic result including the result explanatory sentence.

### Supplementary Note 42

The program described in Supplementary Note 41, in which
the program causes the computer to perform
countermeasure identification processing of identifying a countermeasure for changing the state of the device included in the attack route to the attack target device in such a way to prevent an attack on the attack target device through the attack route from being successful by using information on a countermeasure for changing the state to prevent an attack on the device capable of being successful in the state from being successful, as a countermeasure for the attack target device,
the output information generation processing is performed to generate a countermeasure explanatory sentence describing the countermeasure for the attack target device by using the large language model, and
the output processing is performed to output information on the diagnostic result further including the countermeasure explanatory sentence of the countermeasure for the attack target device in order of magnitude of the management impact in a case where the attack target device is attacked.

While the present disclosure has been particularly shown and described by using example embodiments thereof, the present disclosure is not limited to these example embodiments. It will be understood by those of ordinary skill in the art that various changes in form and details may be made therein without departing from the spirit and scope of the present disclosure as defined by the claims.

What is claimed is:

1. A diagnostic device comprising:
at least one memory storing a set of instructions; and
at least one processor configured to execute the set of instructions to:
estimate a management impact that is a magnitude of influence on revenue loss resulting due to an attack on a device included in a diagnostic target system based on information on a purpose of the device;
identify an entry point device and an attack target device in the device by using information on a configuration of the diagnostic target system and the management impact of the device, the entry point device being a device capable of being caused to be an entry point, the attack target device being a device capable of being caused to be a target of the attack;
detect an attack route through which the attack from the entry point device to the attack target device is capable of being successful by using the information on the configuration of the diagnostic target system, information on a state of the device, and information on an attack capable of being successful in the state; and
output information on a diagnostic result indicating the management impact due to the attack on the attack target device through the detected attack route.

2. The diagnostic device according to claim 1, wherein
the at least one processor is configured to execute the set of instructions to
output information on the diagnostic result including information on the attack route.

3. The diagnostic device according to claim 1, wherein
the state of the device include a state of vulnerability of the device and a state of setting of the device, and
the at least one processor is configured to execute the set of instructions to:
generate a diagnostic list based on information representing contents of the vulnerability of the device, the diagnostic list being a list of diagnostic items representing information indicating an attack capable of being successful in the state, a type of risk caused by the attack, and a condition under which the risk of the type occurs;
detect the attack route by using the state of the device and the diagnostic list: and
estimate, by using the diagnostic list, the diagnostic result indicating the management impact due to the risk caused by the attack in a case where the attack become successful on the attack target device through the detected attack route.

4. The diagnostic device according to claim 1, wherein
the at least one processor is configured to execute the set of instructions to:
output a screen representing the configuration of the diagnostic target system in which the entry point device and the attack target device are indicated;
acquire selection information indicating the attack target device selected on the screen; and
output the screen on which impact information is superimposed, the impact information being information on the management impact due to an attack on the attack target device indicated by the selection information.

5. The diagnostic device according to claim 1, wherein
the at least one processor is configured to execute the set of instructions to
detect the attack route by performing a simulation of an attack from the entry point device to the attack target device by using the information on the configuration of the diagnostic target system.

6. The diagnostic device according to claim 1, wherein
the at least one processor is configured to execute the set of instructions to:
receive an instruction on contents of the management impact; and
estimate the management impact of the contents.

7. The diagnostic device according to claim 6, wherein
the instruction on the contents includes a loss,
the information on the purpose of the device includes a product whose shipment is related to the device and information on sales of the product, and
the at least one processor is configured to execute the set of instructions to
estimate, in a case where the instruction on the contents includes the loss, the management impact including a magnitude of the amount of decrease in sales of the product whose shipment is related to the attack target device as the management impact.

8. The diagnostic device according to claim 6, wherein
the instruction on the contents includes a loss,
the information on the purpose of the device includes information on stored information that is information stored in the device and information on an estimated loss due to leakage of the stored information in a case where the stored information is leaked, and
the at least one processor is configured to execute the set of instructions to
estimate the management impact including a magnitude of the estimated loss due to the leakage of the stored information in a case where the stored information in the attack target device is leaked due to an attack on the attack target device, as the less in a case where the instruction on the contents is the loss.

9. The diagnostic device according to claim 6, wherein
the instruction on the contents includes rule violation, and
the at least one processor is configured to execute the set of instructions to
estimate the management impact including information on a rule that is violated in the state of the device of the diagnostic target system among one or more rules to be followed by the diagnostic target system, as the management impact in a case where the instruction on the contents is the rule violation.

10. The diagnostic device according to claim 9, wherein
the information on the purpose of the devices includes information on stored information that is information stored in the device, and
the at least one processor is configured to execute the set of instructions to
estimate the management impact including the information on the rule that is violated in a case where the stored information on the attack target device is leaked due to an attack on the attack target device.

11. The diagnostic device according to claim 9, wherein
the at least one processor is configured to execute the set of instructions to:
generate a list of requirements to be satisfied by the diagnostic target system, by using a large language model, from information on the rules to be followed by the diagnostic target system;
estimate whether the requirements included in the list are satisfied by using the configuration of the diagnostic target system and the state of the device; and
estimates the rule that is violated by using information on an unsatisfied requirement among the requirements.

12. The diagnostic device according to claim 1, wherein
the at least one processor is configured to execute the set of instructions to:
generate a virtual model representing the diagnostic target system by using the information on the configuration of the diagnostic target system and information on the device; and
estimate the diagnostic result by using the virtual model.

13. The diagnostic device according to claim 1, wherein
the at least one processor is configured to execute the set of instructions to:
generate a result explanatory sentence that is a sentence describing the diagnostic result from the diagnostic result by using a large language model; and
output information on the diagnostic result including the result explanatory sentence.

14. The diagnostic device according to claim 13, wherein
the at least one processor is configured to execute the set of instructions to:
identify, as a countermeasure for the attack target device, a countermeasure changing the state of the device included in the attack route to the attack target device in such a way to prevent an attack on the attack target device through the attack route from being successful by using information on a countermeasure for changing the state to prevent an attack on the device to be successful in the state from being successful;
generate a countermeasure explanatory sentence describing the countermeasure for the attack target device by using the large language model; and
output information on the diagnostic result further including the countermeasure explanatory sentence of the countermeasure for the attack target device in order of magnitude of the management impact in a case where the attack target device is attacked.

15. A diagnostic method comprising:
estimating a management impact that is a magnitude of an influence on management due to an attack on a device included in a diagnostic target system based on information on a purpose of the device;
identifying an entry point device and an attack target device in the device by using information on a configuration of the diagnostic target system and the management impact of the device, the entry point device being a device capable of being caused to be an entry point, the attack target device being a device capable of being caused to be a target of the attack;
detecting an attack route through which the attack from the entry point device to the attack target device is capable of being successful by using the information on the configuration of the diagnostic target system, information on a state of the device, and information on an attack capable of being successful in the state; and
outputting information on a diagnostic result indicating the management impact due to the attack on the attack target device through the detected attack route.

16. The diagnostic method according to claim 15, further comprising
outputting information on the diagnostic result including information on the attack route.

17. The diagnostic method according to claim 15, wherein
the state of the device include a state of vulnerability of the device and a state of setting of the device, and
the diagnostic method further comprises:
generating a diagnostic list based on information representing contents of the vulnerability of the device, the diagnostic list being a list of diagnostic items representing information indicating an attack capable of being successful in the state, a type of risk caused by the attack, and a condition under which the risk of the type occurs;
detecting the attack route by using the state of the device and the diagnostic list: and
estimating, by using the diagnostic list, the diagnostic result indicating the management impact due to the risk caused by the attack in a case where the attack become successful on the attack target device through the detected attack route.

18. The diagnostic method according to claim 15, further comprising:
outputting a screen representing the configuration of the diagnostic target system in which the entry point device and the attack target device are indicated;
acquiring selection information indicating the attack target device selected on the screen; and
outputting the screen on which impact information is superimposed, the impact information being information on the management impact due to an attack on the attack target device indicated by the selection information.

19. The diagnostic method according to claim 15, further comprising
detecting the attack route by performing a simulation of an attack from the entry point device to the attack target device by using the information on the configuration of the diagnostic target system.

20. A non-transitory computer readable storage medium storing a program that causes a computer to perform processing, the processing comprising:
estimation processing of estimating a management impact that is a magnitude of an influence on management due to an attack on a device included in a diagnostic target system based on information on a purpose of the device;
identification processing of identifying an entry point device and an attack target device in the device by using information on a configuration of the diagnostic target system and the management impact of the device, the entry point device being a device capable of being caused to be an entry point, the attack target device being a device capable of being caused to be a target of the attack;
detection processing of detecting an attack route through which the attack from the entry point device to the attack target device is capable of being successful by using the information on the configuration of the diagnostic target system, information on a state of the device, and information on an attack capable of being successful in the state; and
output processing of outputting information on a diagnostic result indicating the management impact due to the attack on the attack target device through the detected attack route.
